(19) United States
(12) Patent Application Publication
(10) Pub. No.: US 2026/0018328 A1
(43) Pub. Date: Jan. 15, 2026

(54) Electronic Component, Electric Device, Bus Bar, Method For Manufacturing Electronic Component, And Method For Manufacturing Electric Device

(71) Applicant: SUMIDA CORPORATION, Tokyo (JP)

(72) Inventors: Takenori FUKUCHI, Natori City (JP); Ryoga KOYAMA, Natori City (JP); Ryota ISHII, Natori City (JP); Yusuke HATANO, Natori City (JP)

(21) Appl. No.: 19/338,309

(22) Filed: Sep. 24, 2025

Related U.S. Application Data
(63) Continuation of application No. PCT/JP2023/013995, filed on Apr. 4, 2023.

(51) Int. Cl. H01F 27/29

(52) U.S. Cl. CPC H01F 27/29

(57) ABSTRACT

An electronic component includes a main body and a bus bar. The main body includes an electronic element. The bus bar is electrically connected to the electronic element. The bus bar includes a hole. The hole opens at a contact surface. An unevenness region is formed at the contact surface. The unevenness region has an unevenness structure around the hole.

### CROSS REFERENCE TO RELATED APPLICATIONS

This application is a continuation of International Patent Application no. PCT/JP2023/013995, filed on Apr. 4, 2023, which is expressly incorporated herein by reference in its entirety.

### BACKGROUND

### Technical Field

The present invention relates to an electronic component, an electric device, a bus bar, a method for manufacturing the electronic component, and a method for manufacturing the electric device.

### Related Art

There are some electronic components including bus bars and electrically connected to other conductive members (hereinafter, also referred to as contacting members) through the bus bars. With regard to such a type of technique, Japanese Patent Laid-Open No. 2015-139289 (Patent Document 1) discloses a switching device 1 including an input bus bar 30 and an output bus bar 40. It is also described that a nickel plating layer 37 is provided on a surface of the input bus bar 30. Fastening terminals 101A and 101B connected to wire harnesses 100A and 100B coupled to a battery are fixed to these bus bars 30 and 40, respectively. Specifically, stud bolts 110A and 110B are inserted into through holes provided in the bus bars 30 and 40, respectively, and nuts 113A and 113B are fastened to tips of the stud bolts 110A and 110B, respectively, whereby the bus bars 30 and 40 are fixed to the fastening terminals 101A and 101B, respectively.

The electronic component and the contacting member (the fastening terminals 101A and 101B in Patent Document 1) are electrically connected to each other by being in contact with each other. When an electrical connection resistance at the contact surface is large, at least one of problems occurs in which a current passing through the electronic component and the contacting member decreases and heat generation causes deformation or the like of members around the contact surface.

The present invention has been made in consideration of the above problems, and is to provide an electronic component, an electronic device, a bus bar, a method for manufacturing an electronic component, and a method for manufacturing an electronic device that reduce current loss.

### SUMMARY

The present invention provides an electronic component including: a main body including an electronic element; and a bus bar that is electrically connected to the electronic element, and the bus bar includes a hole, and an unevenness region having an unevenness structure is formed around the hole in a contact surface where the hole opens.

The present invention provides an electric device including: an electronic component including a main body including an electronic element and a bus bar electrically connected to the electronic element; and a second bus bar that is in contact with the bus bar, the bus bar includes a hole, an unevenness region having an unevenness structure is formed around the hole in a contact surface where the hole opens, the second bus bar is in contact with the contact surface at a facing surface that faces the contact surface, and a top portion, which is a leading end protruding in the unevenness structure, fits into the second bus bar.

The present invention provides a bus bar including a hole that is a conductor, and an unevenness region having an unevenness structure is formed around the hole in a contact surface where the hole opens.

The present invention provides a method for manufacturing an electronic component including a main body including an electronic element, and a bus bar that is electrically connected to the electronic element, the method including: forming a hole in a scheduled hole forming region; and embossing an unevenness structure by pressing a pressing member against the hole or a periphery of the scheduled hole forming region to form the unevenness structure around the hole or the scheduled hole forming region, in which, forming a hole and embossing the unevenness structure are performed simultaneously or sequentially.

The present invention provides a method for manufacturing an electric device including an electronic component including a main body including an electronic element and a bus bar electrically connected to the electronic element, and a second bus bar that is in contact with the bus bar, in which, the bus bar includes a hole, an unevenness region having an unevenness structure is formed around the hole in a contact surface where the hole opens, and the method includes: arranging the bus bar and the second bus bar such that the contact surface faces a facing surface of the second bus bar and allowing the contact surface and the facing surface to come into pressure contact with each other such that a part of the unevenness structure fits into the second bus bar.

### Effect of the Invention

According to an electronic component of the present invention, since a bus bar has an unevenness structure, the unevenness structure can bite into a contacting member being in contact with the bus bar and can come into contact with the bus bar. This makes it possible to increase a contact area between the bus bar and the contacting member, and to allow the bus bar to bite into the contacting member and come into pressure contact with the contacting member, whereby electrical connection resistance can be reduced and current loss can be prevented.

### BRIEF DESCRIPTION OF THE DRAWINGS

The above objects, other objects, features, and advantages will become more apparent from the following preferred embodiments and the accompanying drawings.

FIG. 1A is a perspective view showing an example of an electronic component according to a first embodiment of the present invention. FIG. 1B is a front view of a first bus bar.

FIG. 2A is a cross-sectional view taken along a dashed line shown in FIG. 1B of the electronic component according to the first embodiment as viewed in a direction of arrow II-II. FIG. 2B is an enlarged view of a region X in FIG. 2A.

FIG. 3A is a schematic diagram of an electronic device according to the first embodiment. FIG. 3B is a schematic diagram of a joined portion between a first bus bar and a second bus bar. FIG. 3C is a schematic enlarged cross-sectional view showing a joining mode with a second bus bar at a peripheral edge portion of a first bus bar.

FIG. 4A is a graph showing an example of a value of electrical connection resistance of a first bus bar having an unevenness structure or a bus bar not having an unevenness structure. FIG. 4B is a graph showing an example of a value of electrical connection resistance of a first bus bar including an oxide film or a bus bar not including an oxide film.

FIG. 5A is a perspective view showing an example of an electronic component according to a second embodiment of the present invention. FIG. 5B is a front view of a first bus bar.

FIG. 6A is a cross-sectional view taken along a dashed line shown in FIG. 5B of the electronic component according to the second embodiment as viewed in a direction of arrow V-V. FIG. 6B is an enlarged view of a region Z in FIG. 6A. FIG. 6C is an enlarged view of a region Y in FIG. 6A.

FIG. 7A is a schematic enlarged cross-sectional view showing a joining mode with a second bus bar at an outer peripheral edge portion of a first bus bar in the electronic component according to the second embodiment. FIG. 7B is a schematic enlarged cross-sectional view showing a joining mode with a second bus bar at an inner peripheral edge portion of a first bus bar.

### DETAILED DESCRIPTION

Various components of an electronic component, an electric device, and a bus bar according to the present invention do not need to be individually independent. Various components are allowed, for example, one member may be formed of a plurality of components, one component may be formed of a plurality of members, a component may be part of another component, or part of a component may be duplicated as part of another component.

In a manufacturing method of an electronic component or an electronic device of the present invention, a plurality of steps are sequentially described; however, the sequence of the descriptions of the steps does not limit the sequence or timing to execute the plurality of steps. For this reason, when the manufacturing method of the electronic component or the electronic device of the present invention is performed, the sequence of the plurality of steps is capable of being changed without departing from the content, and part or the entirety of the timings to execute the plurality of steps may be duplicated.

Hereinafter, embodiments of the present invention will be described with reference to the drawings. In all of the drawings, the same reference numerals will be given to the same components, and thus will not be described as appropriate.

In the present embodiment, an x direction, a y direction, and a z direction are defined as shown in the drawings. However, these are defined for the sake of convenience in order to easily describe the relative relationships between components, and do not limit the directions during the manufacture or use of the product embodying the present invention.

Further, a term “flat surface” as used herein means a shape that is physically formed with a flat surface as a goal, and it is not necessarily required that the surface be a geometrically perfect flat surface.

### First Embodiment

### (Electronic Component)

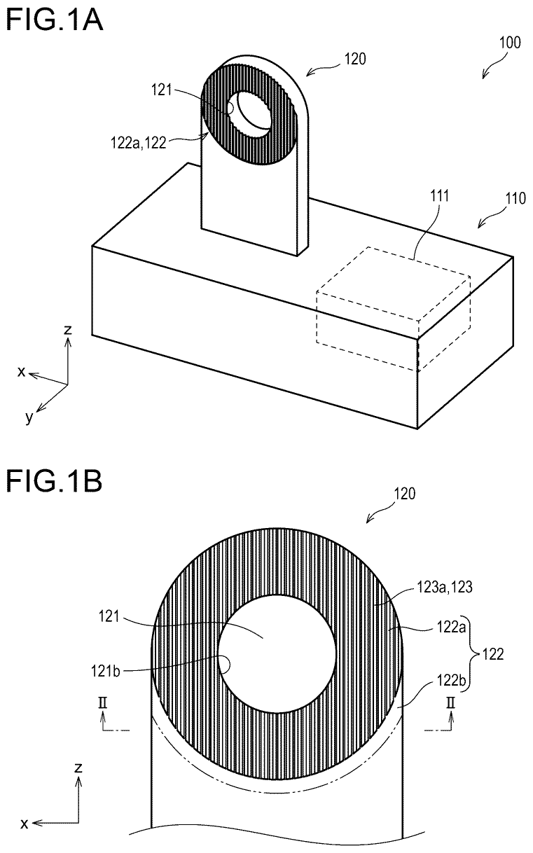

FIG. 1A is a perspective view showing an example of an electronic component 100 according to a first embodiment of the present invention.

First, an overview of the electronic component 100 according to the present embodiment will be described.

The electronic component 100 includes a main body 110 and a bus bar (a first bus bar 120). The main body 110 includes an electronic element 111. The first bus bar 120 is electrically connected to the electronic element 111. The first bus bar 120 includes a hole 121. In a contact surface 122 where the hole 121 opens, an unevenness region 122a is formed, the unevenness region having an unevenness structure 123 (see FIG. 1B) around the hole 121.

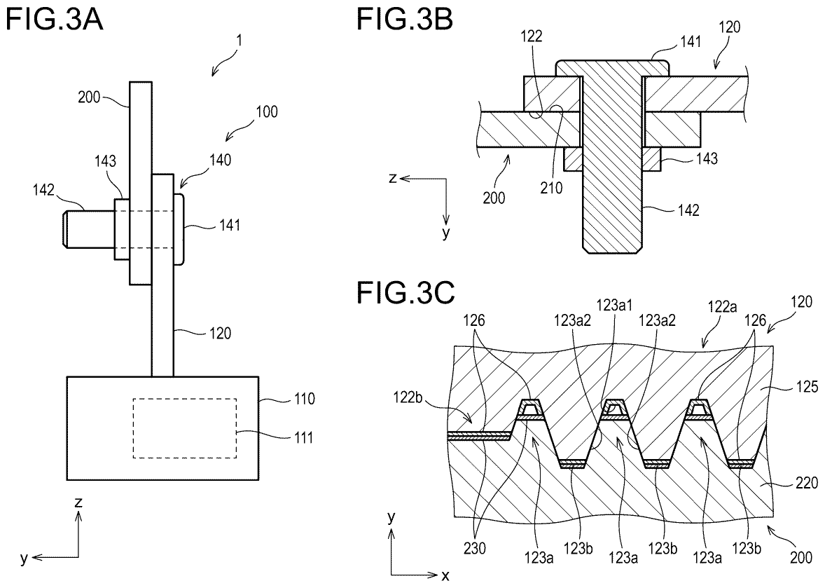

Since the first bus bar 120 has the unevenness structure 123 (see FIG. 1B), the unevenness structure 123 bites into a contacting member (a second bus bar 200 (see FIG. 3A) to be described below) coming into contact with the first bus bar 120, whereby the first bus bar 120 can come into contact with the second bus bar 200. Thus, a contact area between the first bus bar 120 and the contacting member increases compared to a case where a bus bar not having the unevenness structure 123 and having a flat contact surface abuts or comes into pressure contact with the contacting member. Alternatively, the first bus bar 120 bites into the contacting member, whereby the first bus bar 120 comes into pressure contact with the contacting member, and the first bus bar 120 and the contacting member may be bonded to each other at their surfaces due to the pressure-welding. This makes it possible to reduce electrical connection resistance and prevent current loss.

Next, the electronic component 100 according to the present embodiment will be described in detail.

The electronic component 100 refers to a portion including the electronic element 111 that constitutes an electronic circuit. In particular, the electronic component 100 refers to components that can be connected to or removed from the contacting member. The electronic element 111 is a component in the electronic component 100, and is a part including a core or a coil that constitutes an electronic circuit. A main function of the electronic component 100 is implemented by the electronic element 111. The electronic element 111 may include a core or a coil, and the electronic component 100 may be, as a whole, a coil component such as an inverter, an inductor, a transformer, or an antenna. In the present embodiment, the electronic component 100 is an in-vehicle electronic component that constitutes an electric device mounted on a vehicle body of an automobile. More specifically, an example of the electric device includes a battery device such as a lithium ion battery or an all-solid-state battery mounted on an electric vehicle. The electronic component 100 may be any of various reactors that are connected to an electric device, which is an in-vehicle battery device, and a current is applied to the reactors during charging or discharging.

The main body 110 is a part of the electronic component 100, and includes the electronic element 111. The main body 110 preferably includes the electronic element 111 therein. The whole of the main body 110 may be covered with a molded resin or the like. In the present embodiment, the main body 110 is a member having a shape in which a longitudinal direction is an x-axis direction, but the main body 110 may have any shape.

The bus bar is formed of a conductive material such as a metal containing copper. Preferably, the bus bar has an area of a cross section (a cross section cut horizontally with respect to the contact surface 122 to be described below) larger than that of a wire, and has an overall shape that is substantially rod-like or plate-like. In the present embodiment, the electronic component 100 or an electric device 1 to be described below includes, as a bus bar, the first bus bar 120 or the second bus bar 200. Hereinafter, a longitudinal direction of the bus bar may refer to a direction, in which the bus bar has the largest dimension, among a height direction, a width direction, and a thickness direction of the bus bar. In the present embodiment, the longitudinal direction of the first bus bar 120 and the second bus bar 200 (see FIG. 3A) is a z-axis direction. In the present embodiment, a cross section of the first bus bar 120 is a cross section cut horizontally with respect to the contact surface 122, in other word, a cross section cut vertically in a plate thickness direction (y direction) from the first bus bar 120. The cross section of the bus bar may have a polygon shape such as a rectangular shape, or may have a circular shape or an elliptical shape.

The first bus bar 120 is a member that electrically connects the contacting member connected to the electronic component 100 with the electronic element 111. In the present embodiment, a part of a base end side (−z direction) of the first bus bar 120 is embedded inside the main body 110, and another part of a leading end side (z direction) protrudes outward from the main body 110. As shown in FIG. 1B, an outer edge of the leading end of the first bus bar 120 is semicircular in shape along a peripheral wall surface 121b that defines the hole 121 to be described below. In the present embodiment, as shown in FIG. 1A, the first bus bar 120 is electrically connected to the electronic element 111 inside the main body 110.

In the present embodiment, the electronic component 100 includes one first bus bar 120, but the electronic component 100 may include a plurality of first bus bars 120.

The hole 121 of the first bus bar 120 is a hole into which a shaft member 140 (see FIG. 3A), which will be described below, is inserted. The hole 121 may be a through hole as in the present embodiment, or may be a bottomed concave-shaped portion. The hole 121 is defined by the peripheral wall surface 121b, which is also a part of the outer surface of the first bus bar 120. A penetrating direction or a depth direction (hereinafter, collectively referred to as a penetrating direction, that is, a y-axis direction) of the hole 121 is preferably a direction orthogonal to the longitudinal direction (z-axis direction) of the first bus bar 120. Specifically, as shown in FIG. 3B, the penetrating direction of the hole 121 is preferably a direction equal to the direction (y-axis direction) in which the first bus bar 120 and the contacting member (second bus bar 200 (see, for example, FIG. 3A)) coming in contact with the first bus bar 120 are aligned.

As shown in FIG. 1B, in the present embodiment, the shape of the hole 121 is circular as viewed from in the penetrating direction of the hole 121, but is not limited thereto. Such a shape may be a polygonal shape such as a rectangular shape, or may be an elliptical shape other than the circular shape. The shape and dimensions in the penetrating direction of the hole 121 are preferably sufficient to allow the shaft member 140 (see FIG. 3A) to be inserted thereinto. In other words, as shown in FIG. 3B and will be described below, when the shaft member 140 is inserted into the hole 121, it is preferable that a gap is caused between the peripheral wall surface 121b of the hole 121 and a peripheral surface of the shaft member 140. Specifically, when the shape of the hole 121 is circular as viewed in the penetrating direction of the hole 121 and a transverse section of the shaft member 140 is circular, a radius of the hole 121 is preferably larger than a radius of the transverse section of the shaft member 140 (particularly, a shaft portion 142).

As shown in FIG. 1B, the hole 121 is open at least in the contact surface 122. When the hole 121 is a through hole, the hole 121 is open in the contact surface 122 and in a rear surface (a surface directed to the −y direction of the first bus bar 120) that is arranged on a side opposite in front and back to the contact surface 122. The contact surface 122 is a partial region of the outer surface of the first bus bar 120. The contact surface 122 is a partial surface region that is in contact with the contacting member (for example, the second bus bar 200), or a partial surface region that is scheduled to come into contact with the contacting member. The contact surface 122 may be formed only by the surface region that is in contact or is scheduled to come into contact with the contacting member, or may include surface regions, which are not in contact with the contacting member or are not scheduled to come into contact with the contacting member, around the surface region.

The unevenness region 122a is a partial region of the contact surface 122, and refers to a surface region in which the unevenness structure 123 is formed. In other words, the unevenness region 122a is a region that is larger in unevenness than another region (for example, an outer peripheral portion 122b) adjacent to the outside of the unevenness region 122a. The unevenness region 122a is a plane region that extends in an approximately extending direction of the contact surface 122.

That the unevenness region 122a is formed around the hole 121 means that the unevenness region 122a is formed on a part of the contact surface 122 close to the hole 121. More specifically, the shortest distance along the contact surface 122 between the hole 121 and the unevenness region 122a (a distance between the peripheral wall surface 121b of the hole 121 and the peripheral edge of the unevenness region 122a as viewed in the penetrating direction of the hole 121) is preferably smaller than an overhanging dimension of a shaft head portion 141 to be described below. Here, the overhanging dimension of the shaft head portion 141 indicates a height of an outer peripheral edge of the shaft head portion 141 based on a peripheral surface of the shaft portion 142. Alternatively, the distance is preferably smaller than the radius of the hole 121. More preferably, the distance is 0. When the unevenness region 122a is arranged around the hole 121 in this manner, the shaft member 140 (particularly, the shaft head portion 141) can sufficiently apply stress for the unevenness structure 123, which will be described below, to fit into the contacting member (for example, the second bus bar 200).

In the present embodiment, the unevenness region 122a is formed so as to completely surround the periphery of the hole 121. In other words, the unevenness region 122a is formed omnidirectionally on an outer side in a diameter directions of the hole 121. Here, the diameter direction of the hole 121 is a direction extending in the penetrating direction of the hole 121 and directed from an axial center passing through the center of the hole 121 toward the peripheral wall surface 121b that defines the hole 121. Alternatively to the present embodiment, the unevenness region 122a may be formed on a part of the outer side in the diameter direction of the hole 121.

The unevenness region 122a is a partial surface region of one surface (a surface directed to the y direction) including the contact surface 122 on the outer surface of the first bus bar 120. In other words, when viewed facing the contact surface 122, a part or whole of the outer peripheral edge of the unevenness region 122a is preferably arranged inward from the outer peripheral edge of the first bus bar 120. In the present embodiment, as shown in FIG. 1B, a part of the outer peripheral edge of the unevenness region 122a arranged on the base end side (a part on a lower side in the drawing) is arranged inward from the outer peripheral edge of the first bus bar 120.

In addition, when the first bus bar 120 is joined to the second bus bar 200 to be described below, the unevenness region 122a may be formed in a part (hereinafter, also referred to as an overlapping portion), which overlaps the second bus bar 200 as viewed in the penetrating direction of the hole 121, of the surface directed to the y direction. The outer peripheral edge of the unevenness region 122a may be arranged outside or inside the overlapping portion as viewed in the penetrating direction of the hole 121.

The unevenness structure 123 is a structure having a plurality of concave portions or convex portions. As described above, the unevenness region 122a has, as a whole, the unevenness structure 123, and thus has a rough surface having a larger surface roughness than a peripheral region (for example, the outer peripheral portion 122b to be described below) of the unevenness region 122a.

Here, the concave portion in the unevenness structure 123 is a portion that is arranged on a protruding inner side of the first bus bar 120 in the unevenness region, and the convex portion of the unevenness structure 123 is a portion that is arranged on a protruding outer side of the first bus bar 120 in the unevenness region 122a. Here, the protruding inner side refers to a direction from the outer surface toward the center of the first bus bar, and the protruding outer side refers to a direction from the center toward the outer surface of the first bus bar.

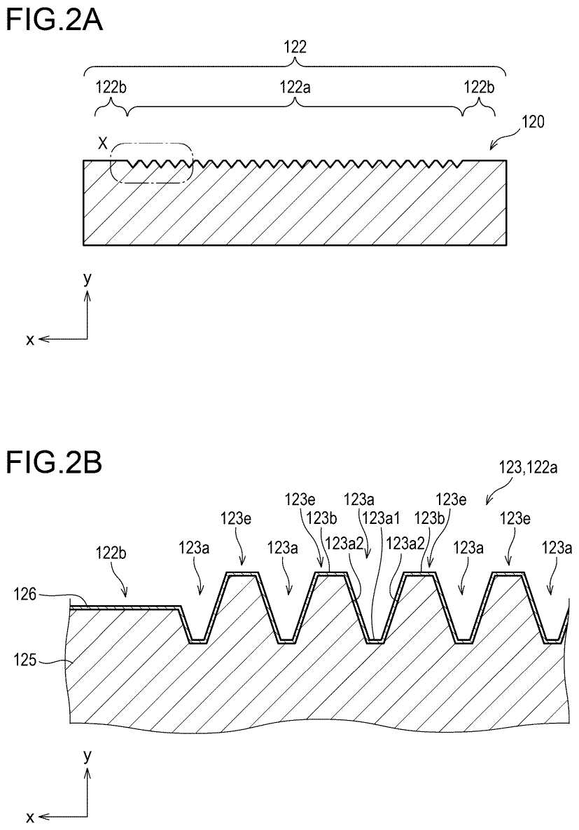

As shown in FIG. 1B, the unevenness structure 123 of the present embodiment is formed by two or more bottomed concave grooves 123a aligned with each other. The concave groove 123a is defined by a bottom portion (concave-groove bottom portion 123a1 (see FIG. 2B)) and a pair of wall portions (concave-groove wall portion 123a2 (see FIG. 2B)) that sandwich the concave-groove bottom portion 123al. Here, that the concave grooves 123a are aligned with each other means that extending directions of the concave grooves 123a have the same direction component, and preferably the concave grooves 123a are approximately parallel to each other. The extending direction of the concave grooves 123a may be linear as in the present embodiment, or may wavy. Alternatively, the plurality of concave grooves 123a may have concentric circle shapes with different radii. In other words, the extending direction of the concave grooves 123a may be circular. Even when the concave grooves 123a are wavy or circular, the concave grooves 123a adjacent to each other are preferably aligned with each other.

In the present embodiment, as shown in FIG. 1B, the plurality of concave grooves 123a having substantially a linear shape extend in the longitudinal direction (z-axis direction) of the first bus bar 120. Further, the plurality of concave grooves 123a are also continuously lined up in the direction (x-axis direction) orthogonal to the longitudinal direction. As shown in FIG. 3A, in the present embodiment, the first bus bar 120 and the second bus bar 200 are arranged side by side in the longitudinal direction (z-axis direction) of the first bus bar 120 while overlapping partially in the y-axis direction and coming in contact with each other. The concave grooves 123a extending in the longitudinal direction of the first bus bar 120 extend in line in the direction orthogonal to the longitudinal direction, whereby the contact surface between the first bus bar 120 and the second bus bar 200 is hardly misaligned laterally in a direction intersecting the longitudinal direction. Alternatively to the present embodiment, the concave grooves 123a extend in the direction orthogonal to the longitudinal direction of the first bus bar 120, and the plurality of concave grooves 123a may be aligned in the longitudinal direction.

Compared to the concave groove 123a shown in FIGS. 2B and 3C, widths of the concave-groove bottom portion 123a1 and a top portion 123b and an inclination angle of the concave-groove wall portion 123a2 shown in FIGS. 1A, 1B, and 2A are changed for convenience.

In the present embodiment, the unevenness structure 123 is configured by the plurality of concave grooves 123a, but alternatively to the present embodiment, the unevenness structure 123 may be configured by a plurality of scattered protrusion portions (for example, protrusion portions having a cone shape or a pyramid shape).

As shown in FIG. 2B, the unevenness structure 123 of the present embodiment can be said to include a plurality of protrusion portions 123e. The protrusion portion 123e is a portion that protrudes from the protruding inner side toward the protruding outer side of the first bus bar 120, and is a part of the first bus bar 120. In the present embodiment, the protrusion portion 123e is a part of the first bus bar 120 located between one concave groove 123a and another concave groove 123a adjacent to the one concave groove 123a. More specifically, the protrusion portion 123e is a part of the first bus bar 120 defined by the concave-groove wall portions 123a2 that define the concave groove 123a and the top portion 123b. In the present embodiment, the protrusion portion 123e extends in a substantially linear extending direction along the concave groove 123a.

The width of the protrusion portion 123e becomes preferably smaller toward the protruding direction of the unevenness structure 123. In addition, a protruding dimension of the protrusion portion 123e is preferably larger than a width dimension of the protrusion portion 123e (particularly, a width dimension of a base end of the protrusion portion 123e). This makes it easier for the protrusion portion to fit into the second bus bar 200 in a step for joining to be described below. Hereinafter, the protruding direction of the unevenness structure 123 may be simply referred to as a protruding direction. A width direction of the protrusion portion 123e refers to any direction orthogonal to the protruding direction in which the dimension of the protrusion portion 123e is the smallest. The width dimension of the protrusion portion 123e is a dimension of the protrusion portion 123e in the width direction. In the present embodiment in which the unevenness structure 123 is formed by the plurality of concave grooves 123a aligned with each other, the width dimension of the protrusion portion 123e is a dimension of the protrusion portion 123e in the direction in which the plurality of concave grooves 123a are aligned.

As shown in FIG. 2B, in the present embodiment, the top portion 123b is flat which is a leading end protruding in the unevenness structure 123. In other words, the top portion 123b has a predetermined width dimension.

The top portion 123b is a portion that is arranged on the protruding outer side of the first bus bar 120 in the unevenness structure 123. In the present embodiment, regions located between the plurality of concave grooves 123a are the top portions 123b, and the top portions 123b extend in substantially the same direction as the direction in which the concave grooves 123a extend (z-axis direction). The top portions 123b have a predetermined width dimension in the direction in which the concave grooves 123a are aligned (x-axis direction). When the unevenness structure 123 is configured by scattered protrusion portions, protruding ends of the protrusion portions are the top portions 123b.

Here, the “flat” means that the top portion 123b is planar, or a radius of curvature of the top portion 123b at a point arranged on the protruding outermost side of the protrusion portion is larger than half the width dimension of the protrusion portion (particularly, the width dimension of the protruding leading end). In other words, the top portion 123b may be a curved surface that is gently curved inward or outward of the first bus bar 120. Preferably, the radius of curvature of the top portion 123b is larger than the width dimension of the protrusion portion. More preferably, the top portion 123b is planar.

Alternatively to the present embodiment, the shape of the top portion 123b may be a shape that is sharp outward of the first bus bar 120. In other words, the radius of curvature of the top portion 123b at the point arranged on the protruding outermost side of the protrusion portion may be smaller than half the width dimension of the protrusion portion (particularly, the width dimension of the protruding leading end). Since the top portion 123b is sharp, when the first bus bar 120 and the second bus bar 200 come into pressure contact with each other, the top portion 123b can easily fit into the second bus bar 200.

Since the top portion 123b is flat, in a step for joining to be described below, the top portion 123b comes into surface contact with the surface of the second bus bar 200 before the top portion 123b fits into the second bus bar 200. This prevents the top portion 123b from slipping on the second bus bar 200. As a result, the first bus bar 120 and the second bus bar 200 can continuously come into pressure contact with each other in a desired positional relationship. In addition, the top portion 123b comes concentrically into pressure contact with a predetermined position on the surface of the second bus bar 200, making it easy to fit into the predetermined position.

When pitches of the respective concave grooves 123a are constant, it is possible to increase an inclination angle of the wall portion (the concave-groove wall portion 123a2 to be described below), which defines the concave groove 123a, relative to the outer peripheral portion 122b in a case where the top portion 123b has a width compared to a case where the top portion 123b has substantially no width and is sharp. This makes it easier for an oxide film covering the concave-groove wall portion 123a2 to peel off in the step for joining to be described below.

The width of the top portion 123b interposed between two concave grooves 123a is larger than the bottom portion of the concave groove 123a (the concave-groove bottom portion 123a1). In the present embodiment, the top portion 123b has a predetermined width dimension in the direction in which the plurality of concave grooves 123a are aligned (x-axis direction). In the present embodiment, the concave-groove bottom portion 123a1 has a predetermined width dimension in the direction in which the plurality of concave grooves 123a are aligned (x-axis direction), but is not limited thereto. The concave-groove bottom portion 123a1 may be substantially linear, and the width of the concave-groove bottom portion 123a1 may be substantially zero. Even in this case, the width of the top portion 123b is larger than the width of the concave-groove bottom portion 123a1.

Since the width of the top portion 123b is larger than the width of the concave-groove bottom portion 123a1 as described above, the width of the top portion 123b is sufficiently ensured. For this reason, misalignment between the first bus bar 120 and the second bus bar 200 is satisfactorily prevented in the step for joining as described above.

In the step for joining to be described below, the top portion 123b fits into the second bus bar 200, whereby some of the material of the second bus bar 200 is pushed out and rises around the top portion 123b. Since the concave groove 123a is deeply formed until the width of the concave-groove bottom portion 123a1 is sufficiently small, the part of the second bus bar 200 can fit into the bottom side of the concave groove 123a. As a result, it becomes easy to maintain a state in which the top portion 123b fits into the second bus bar 200. Furthermore, since the contact area between the second bus bar 200 and the first bus bar 120 increases as the part of the second bus bar 200 fits into the bottom side of the concave groove 123a, the electrical connection resistance can be reduced.

Alternatively to the present embodiment, the width of the top portion 123b may be equal to or smaller than the width of the concave-groove bottom portion 123a1.

Moreover, the width of the top portion 123b is preferably smaller than the width of the concave groove 123a at the opening portion of the concave groove 123a. As the width of the top portion 123b is sufficiently small, the top portion 123b can easily fit into the second bus bar 200 in the step for joining to be described below.

As shown in FIG. 1B, the contact surface 122 includes the outer peripheral portion 122b, which is a portion adjacent to the unevenness region 122a, outside the unevenness region 122a.

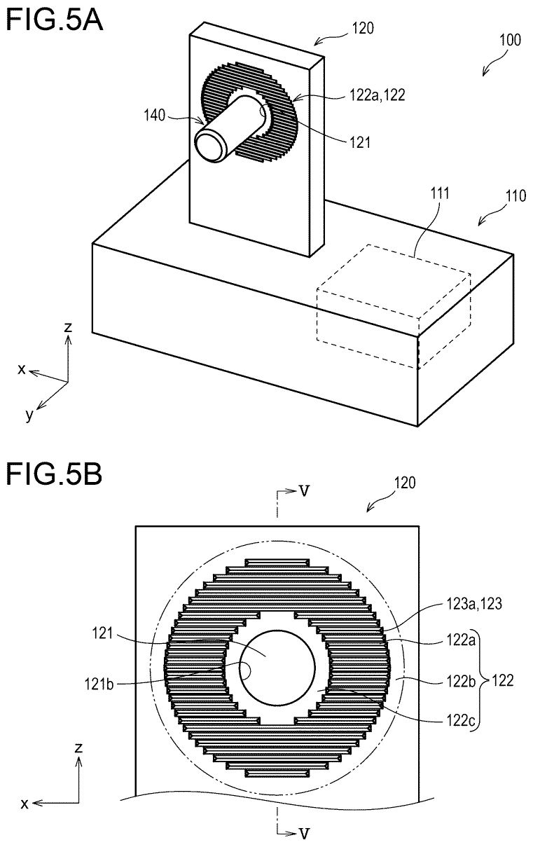

The outer peripheral portion 122b is a partial surface region adjacent to the unevenness region 122a in the contact surface 122, and is a region where the unevenness structure 123 is not formed. In other words, the outer peripheral portion 122b is a region of which surface is formed flatter than the unevenness region 122a. Moreover, the outer peripheral portion 122b is a region located outward of the unevenness region 122a as viewed in the diameter direction of the shaft member 140. For example, the outer peripheral portion 122b is a partial surface region having a predetermined width along a part of the outer edge of the unevenness region 122a. In the present embodiment in which the unevenness region 122a is formed to surround the periphery of the shaft member 140 as viewed in the penetrating direction of the hole 121, the outer peripheral portion 122b is a region that is formed to surround the periphery of the unevenness region 122a as viewed in the penetrating direction and has a predetermined width in the diameter direction of the shaft member 140. In the present embodiment, the outer peripheral portion 122b is a partial surface region that is arranged outward from the unevenness region 122a, on the base end side (−z direction) of the first bus bar 120 rather than the unevenness region 122a. In other words, the outer peripheral portion 122b is a region located between the outer peripheral edge of the unevenness region 122a and a two-dot chain line shown in FIG. 1B. Alternatively to the present embodiment, when the unevenness region 122a is formed only in a part in the diameter direction of the hole 121, the outer peripheral portion 122b is a region formed outside the unevenness region 122a in the part in the diameter direction of the hole 121. The outer peripheral portion 122b in a second embodiment to be described below is a partial surface region that completely surrounds the outer peripheral edge of the unevenness region 122a as shown in FIG. 5B.

As shown in FIG. 2B, the top portion 123b protrudes further than the outer peripheral portion 122b in the protruding direction (y direction) of the unevenness structure 123. In other words, the top portion 123b is arranged further outward than the outer peripheral portion 122b in the protruding direction. Here, the protruding direction of the unevenness structure 123 is a direction from the height of the concave portion (the height of the concave-groove bottom portion 123a1) toward the height of the top portion 123b in the unevenness structure 123. The protruding direction coincides with a direction (y direction) from the contact surface 122 toward the outside of the first bus bar 120, among directions orthogonal to the contact surface 122 (unevenness region 122a).

Since the top portion 123b protrudes further than the outer peripheral portion 122b in the protruding direction of the unevenness structure 123, the top portion 123b comes into contact with the second bus bar 200 before the outer peripheral portion 122b comes into contact with the second bus bar 200 in the step for joining to be described below. As a result, the top portion 123b can easily fit into the second bus bar 200.

Alternatively to the present embodiment, the outer peripheral portion 122b and the top portion 123b may be arranged at the same height in the protruding direction of the unevenness structure 123, or the outer peripheral portion 122b may protrude further than the top portion 123b in the protruding direction of the unevenness structure 123. In this case, wear of the convex portion of the unevenness structure 123 can be prevented.

In the present embodiment, the concave-groove bottom portion 123a1 of the unevenness structure 123 is recessed in a direction opposite to the protruding direction (y direction) of the unevenness structure 123, relative to the outer peripheral portion 122b. As a result, the second bus bar 200 can be favorably fitted into the interior of the first bus bar 120 (i.e., into the interior of the concave groove 123a).

In the present embodiment, the depth dimension of the concave-groove bottom portion 123a1 with reference to the outer peripheral portion 122b (i.e., the dimension in the protruding direction of the unevenness structure 123) is greater than the protruding dimension of the top portion 123b with reference to the outer peripheral portion 122b (i.e., the dimension in the protruding direction of the unevenness structure 123). As a result, the second bus bar 200 can be favorably fitted into the interior of the first bus bar 120.

Alternatively, in place of the present embodiment, the depth dimension of the concave-groove bottom portion 123a1 with reference to the outer peripheral portion 122b (i.e., the dimension in the protruding direction of the unevenness structure 123) may be smaller than the protruding dimension of the top portion 123b with reference to the outer peripheral portion 122b (i.e., the dimension in the protruding direction of the unevenness structure 123). In this case, the top portion 123b of the first bus bar 120 can be easily fitted into the second bus bar 200.

The first bus bar 120 includes a conductor portion 125 and an oxide film 126. The oxide film 126 covers the conductor portion 125. The conductor portion 125 is a portion of the first bus bar 120 which is made of a material such as a metal containing copper with good conductivity. The oxide film 126 is a thin film made of an oxide of the metal used for the conductor portion 125 and formed on a surface of the conductor portion 125. The oxide film 126 is insulating or has a higher resistance than the conductor portion 125. The oxide film 126 covers at least a part of the conductor portion 125. In the first bus bar 120 that is not joined to the second bus bar 200, the oxide film 126 covers at least the whole of the contact surface 122. Over the entire area of the first bus bar 120 that is not joined to the second bus bar 200, it is preferable that the thickness of the oxide film 126 is approximately uniform. In FIGS. 2B, 3C, 6B, and 6C, the thickness of the oxide film 126 is depicted to be larger than the actual thickness of the oxide film for convenience.

### (Bus Bar)

The first bus bar 120 may be provided as a single bus bar without including the main body 110. As described above, the first bus bar 120 is a conductor and includes the hole 121. In the contact surface 122 where the hole 121 opens, the unevenness region 122a having the unevenness structure 123 is formed around the hole 121.

### (Electronic Device)

The electronic component 100 of the present embodiment can be provided as an electric device 1 including the electronic component 100. The electric device 1 includes the electronic component 100 and the second bus bar (second bus bar 200). As described above, the electronic component 100 includes the main body 110 including the electronic element 111 and the first bus bar 120 electrically connected to the electronic element 111. The first bus bar 120 includes the hole 121, and the unevenness region 122a having the unevenness structure 123 is formed around the hole 121 in the contact surface 122 where the hole 121 opens.

The second bus bar 200 contacts with the first bus bar 120. The second bus bar 200 is in contact with the contact surface 122 at a facing surface 210 facing the contact surface 122. As shown in FIG. 3C, the top portion 123b, which is the leading end protruding in the unevenness structure 123, fits into the second bus bar 200.

FIG. 3A is a schematic diagram showing an example of the electric device 1. The electric device 1 is a device including the electronic component 100, and the electric device 1 is for in-vehicle use in the present embodiment. The electric device 1 may include a closed electronic circuit by itself, or the electric device 1 may be electrically connected to another electric device.

The second bus bar 200 is a bus bar electrically connected to the first bus bar 120. The second bus bar 200 may be a bus bar used to be connected to another electric device electrically connected to the electric device 1, or may be a bus bar used to be connected to another electronic component included in the electric device 1. In the present embodiment, the second bus bar 200 is a plate-shaped bus bar. The extending direction of the second bus bar 200 is substantially the same as the extending direction of the first bus bar 120, and the first bus bar 120 and the second bus bar 200 are arranged substantially parallel to each other. As described above, the first bus bar 120 and the second bus bar 200 are arranged so as to partially overlap each other as viewed in an axial direction of the shaft member 140.

The facing surface 210 in the second bus bar 200 refers to a partial surface region on the outer surface of the second bus bar 200, and is a surface including a portion that is in contact with or scheduled to come into contact with the first bus bar 120. The facing surface 210 may include only a portion or the whole of the surface that is in contact with or scheduled to come into contact with the first bus bar 120. The facing surface 210 may further include a partial surface region that is arranged near a surface that is in contact with or scheduled to come into contact with the first bus bar 120, and that is not in contact with or not scheduled to come into contact with the first bus bar 120.

That the part (for example, the top portion 123b) of the first bus bar 120 is fitted into the second bus bar 200 means that the part is arranged within the maximum outer shape of the second bus bar 200. The maximum outer shape of the second bus bar 200 is a three-dimensional shape including the inside of large and small concave portions (not limited to the concave portions in the unevenness structure 123) formed on the surface of the second bus bar 200.

The part of the first bus bar 120, which fits into the second bus bar 200, is not limited to the top portion 123b. It is preferable that not only the top portion 123b but also a part of the leading end side (on the side of the top portion 123b) of the concave-groove wall portion 123a2 engages with the second bus bar 200. More preferably, as shown in FIG. 3C, at least half of the leading end side of the concave-groove wall portion 123a2 engages with the second bus bar 200. In other words, a part of a bottom side of the concave-groove wall portion 123a2 and the concave-groove bottom portion 123a1 are arranged outside the second bus bar 200. Alternatively to the present embodiment, the whole of the concave-groove wall portion 123a2 may fit into the second bus bar 200. In addition, the parts fitting into the second bus bar 200 (the top portion 123b and the part of the concave-groove wall portion 123a2 in the present embodiment) are in surface contact with the second bus bar 200.

The top portion 123b fits into the second bus bar 200 in this manner, whereby the contact area between the second bus bar 200 and the first bus bar 120 can be increased compared to a case where the top portion 123b does not fit into the second bus bar 200. This makes it possible to reduce the electrical connection resistance at the contact surface between the second bus bar 200 and the first bus bar 120.

As shown in FIG. 3C, even in the electric device 1 in which the second bus bar 200 is joined to the first bus bar 120, the first bus bar 120 includes the conductor portion 125 and the oxide film 126. The oxide film 126 covers at least a part of the conductor portion 125. In the electric device 1 in which the first bus bar 120 and the second bus bar 200 are joined to each other, a range of the conductor portion 125 covered by the oxide film 126 differs from a range of the conductor portion 125 covered by the oxide film 126 in the electronic component 100 in which the second bus bar 200 is not joined. Specifically, the outer peripheral portion 122b is a covering portion that is covered with the oxide film 126. On the other hand, at least a part of the unevenness structure 123 is an exposed portion that is exposed from the oxide film 126. The exposed portion is buried in the second bus bar 200.

The covering portion is a partial surface region on the outer surface of the first bus bar 120 where the oxide film 126 is formed and the conductor portion 125 is not exposed. The exposed portion is a partial surface region on the outer surface of the first bus bar 120 where the oxide film 126 is not formed and the conductor portion 125 is exposed. A part or whole of the surface of the unevenness structure 123 is an exposed portion. In the present embodiment, only a part of the surface of the unevenness structure 123 is an exposed portion, and the other part thereof is a covering portion.

That the outer peripheral portion 122b is the covering portion means that at least a part of the outer peripheral portion 122b is the covering portion. Preferably, almost the whole of the outer peripheral portion 122b is the covering portion as in the present embodiment.

As will be described in detail below, in the present embodiment, a part of the concave-groove wall portion 123a2 is the exposed portion, and the other remaining parts on the outer surface of the first bus bar 120 are the covering portions that are covered with the oxide film 126.

In the electric device 1 of the present embodiment in which the first bus bar 120 and the second bus bar 200 are joined to each other, at least a part of the exposed portion in the first bus bar 120 fits into the second bus bar 200. In the present embodiment, almost the whole of the exposed portion fits into the second bus bar 200. At the exposed portion fitting into the second bus bar 200, the conductor portion 125 of the first bus bar 120 is in contact with the second bus bar 200.

Generally, the bus bar is plated with a metal such as nickel to prevent the formation of the oxide film, improve electrical connection, and protect the conductor portion. Since a part of the surface of the unevenness structure 123 is the exposed portion in which the conductor portion 125 is exposed, the first bus bar 120 and the second bus bar 200 come into contact with each other at the exposed portion and are electrically connected to each other. This allows good conductivity to be maintained without metal plating, making it possible to easily manufacture the first bus bar 120. In addition, the conductor portion 125 is exposed in the unevenness structure 123 that is electrically connected with the second bus bar 200, and the outer surfaces of the other portions in the first bus bar 120 are covered with the oxide film 126, whereby the conductor portions 125 are protected in such portions.

As shown in FIG. 3C, the concave-groove wall portion 123a2 is arranged obliquely with respect to the outer peripheral portion 122b. At least a part of the concave-groove wall portion 123a2 is an exposed portion being in contact with the second bus bar 200.

In the present embodiment, a part of the concave-groove wall portion 123a2 on the side of the top portion 123b is the exposed portion, and a part thereof on the side of the concave-groove bottom portion 123a1 is the covering portion. However, the oxide film 126 may remain locally on the part of the concave-groove wall portion 123a2 on the side of the top portion 123b to form the covering portion.

In the present embodiment, the first bus bar 120 is in contact with the second bus bar 200 at the top portion 123b and the concave-groove wall portion 123a2 (particularly, the part on the side of the top portion 123b), but the concave-groove bottom portion 123a1 and the second bus bar 200 are spaced apart from each other. In other words, a gap portion is provided inside concave groove 123a in the vicinity of the concave-groove bottom portion 123al, the gap being defined by the concave-groove bottom portion 123a1, the concave-groove wall portion 123a2, and the second bus bar 200. At least a part of the concave-groove bottom portion 123a1 spaced apart from the second bus bar 200 is a covering portion.

As shown in FIG. 2B, since the concave-groove wall portion 123a2 is arranged obliquely with respect to the outer peripheral portion 122b, the concave-groove wall portion 123a2 is arranged obliquely in the thickness direction in which the second bus bar 200 comes into pressure contact with the first bus bar 120 in the step for joining to be described below. Thus, the oxide film 126 on the concave-groove wall portion 123a2 is easily scraped off by the second bus bar 200, compared to a case where the concave-groove wall portion 123a2 is orthogonal to the outer peripheral portion 122b (that is, stands vertically) or is parallel to the outer peripheral portion 122b.

Furthermore, compared to a case where the concave-groove wall portion 123a2 is orthogonal to the outer peripheral portion 122b or is parallel to the outer peripheral portion 122b, when the concave-groove wall portion 123a2 is oblique with respect to the outer peripheral portion 122b, the contact area between the concave-groove wall portion 123a2 and the second bus bar 200 increases when the top portion 123b is inserted into the second bus bar 200 to the same depth. This makes it possible to reduce the electrical connection resistance.

In the present embodiment, at least a part of the top portion 123b is a covering portion. The thickness of the oxide film 126 at the top portion 123b is preferably smaller than the thickness of the oxide film 126 at the concave-groove bottom portion 123al. This makes it possible to improve the electrical connection between the first bus bar 120 and the second bus bar 200 at the top portion 123b. Alternatively to the present embodiment, the whole of the top portion 123b may be an exposed portion in which the conductor portion 125 is exposed.

Alternatively to the present embodiment, the oxide film 126 may remain on the surface of the unevenness structure 123, and the entire region of the unevenness structure 123 may be a covering portion that is covered with the oxide film 126. In this case, the thickness of the oxide film 126 may be approximately uniform or may not be uniform in the unevenness structure 123. For example, the oxide film 126 fitting into the second bus bar 200 may be thinner than the oxide film 126 arranged outside the second bus bar 200. For example, the thickness of the oxide film 126 covering a part of the concave-groove wall portion 123a2 on the side of the top portion 123b may be smaller than the thickness of the oxide film 126 covering the concave-groove bottom portion 123a1.

The second bus bar 200 includes a second conductor portion 220 and a second oxide film 230 that covers the second conductor portion 220. A part of the outer surface of the second bus bar 200 coming into contact with the first bus bar 120 (a part of the facing surface 210) is a second exposed portion in which the second conductor portion 220 is exposed. The other part of the outer surface of the second bus bar 200 is a second covering portion that is covered with the second oxide film 230.

The second conductor portion 220 is a portion of the second bus bar 200 which is made of a material such as copper having good conductivity. The second oxide film 230 is a thin film formed on the surface of the second conductor portion 220 by an oxide of the metal in the second conductor portion 220. The second oxide film 230 is insulating or has a higher resistance than the second conductor portion 220. The second oxide film 230 covers at least a part of the second conductor portion 220. The second oxide film 230 preferably covers substantially the whole of the second conductor portion 220. Here, that the second oxide film 230 covers substantially the whole of the second conductor portion 220 means that a part of the facing surface 210 has a minute surface region (a second exposed portion to be described below) where the conductor portion 125 is exposed without being covered with the oxide film 126.

A part or whole of a portion of the facing surface 210 being in contact with the first bus bar 120 is the second exposed portion in which the second conductor portion 220 is exposed, but a portion of the facing surface 210 not being in contact with the first bus bar 120 may be a second covering portion that is covered with the second oxide film 230. Specifically, a part of the facing surface 210 facing and being in contact with the concave-groove wall portion 123a2 is the second exposed portion. Moreover, a part of the facing surface 210 facing and being in contact with the top portion 123b or the outer peripheral portion 122b is the second covering portion. Furthermore, a part of the facing surface 210 facing and spaced apart from the concave-groove bottom portion 123a1 is also the second covering portion. A thickness of the second oxide film 230 in the second covering portion facing and space apart from the concave-groove bottom portion 123a1 is preferably larger than a thickness of the second oxide film 230 in the part facing and being in contact with the top portion 123b or the outer peripheral portion 122b.

A part of the outer surface of the second bus bar 200 coming into contact with the first bus bar 120 is regarded as the second exposed portion, and the other parts are covered with the second oxide film 230, whereby plating of the second bus bar 200 cannot be necessary.

As shown in FIG. 3B, in the present embodiment, the first bus bar 120 and the second bus bar 200 are joined together and maintained by the shaft member 140 (see FIG. 3A). The shaft member 140 is a long member including the shaft portion 142 that is inserted into the hole 121 in the first bus bar 120 and a hole provided in the second bus bar 200. As shown in FIG. 3B, the shaft member 140 in the present embodiment is a bolt. The shaft member 140 includes the shaft head portion 141 that has a larger diameter than the shaft portion 142, which is inserted into the bus bars, at one end of the shaft portion 142. A nut 143 is tightened from the other end of the shaft member 140, and the first bus bar 120 and the second bus bar 200 are fastened together by the shaft head portion 141 and the nut 143, whereby the first bus bar 120 and the second bus bar 200 are joined and maintained.

Alternatively to the present embodiment, the shaft member 140 may not include the shaft head portion 141. In this case, for example, after the shaft portion 142 is inserted into the hole 121, the one end of the shaft member 140 may be fixed to a part of the first bus bar 120 by welding or the like, and the first bus bar 120 and the second bus bar 200 may be interposed between the one end of the shaft member 140 and the nut 143 to be joined and maintained. Alternatively, the one end of the shaft member 140 may be fixed to, for example, a wall portion of another member by welding or the like, and the first bus bar 120 and the second bus bar 200 may be interposed between the wall portion and the nut 143 to be joined and maintained.

### (Method for Manufacturing Electronic Component)

A method for manufacturing the electronic component 100 of the present embodiment (hereinafter, sometimes referred to as the present method) will be described below.

First, an overview of the present method will be described.

As described above, the present method is a method for manufacturing the electronic component 100 including the main body 110 including the electronic element 111, and the first bus bar 120 electrically connected to the electronic element 111. The present method includes a step for forming a hole and a step for embossing the unevenness.

Subsequently, the present method will be described in detail.

First, a step for forming a hole will be described. In the step for forming a hole, the hole 121 is formed in a scheduled hole forming region. The scheduled hole forming region is a partial surface region on the outer surface of the conductive member that is a member of the first bus bar 120, and is a region where the hole 121 is scheduled to be formed. The conductive member may be formed to the outer shape of the first bus bar 120 by cutting or the like before the hole 121 is formed in the step for forming a hole. In this case, one hole 121 may be formed in the conductive member having the outer shape of the first bus bar 120. Hereinafter, the conductive member having the outer shape of the first bus bar 120 may be referred to as the first bus bar 120. Alternatively, before a step for embossing the unevenness to be described below after the hole 121 is formed in the step for forming a hole, or after the step for forming a hole and after the step for embossing the unevenness, a conductive member formed with a plurality of holes 121 may be cut to match the outer shape of the first bus bar 120 to manufacture a plurality of first bus bars 120. Alternatively, the outer shape of the first bus bar 120 and the hole 121 may be formed simultaneously by one punch member.

When the step for forming a hole is performed after the step for embossing the unevenness as will be described below, the scheduled hole forming region is in the vicinity of the unevenness region 122a. Preferably, the scheduled hole forming region is approximately the center of the unevenness region 122a.

Next, the step for embossing the unevenness will be described. The step for embossing the unevenness is a step in which the unevenness structure 123 is marked on the first bus bar 120. Specifically, a pressing member (not shown) is pressed around the hole 121 or the scheduled hole forming region. Thus, the unevenness structure 123 is formed around the hole 121 or the scheduled hole forming region. The pressing member is a member that is pressed against the first bus bar 120 or the conductive member (hereinafter, which may be collectively referred to as the first bus bar 120) to form the unevenness structure 123. The pressing member includes a pressing surface region on its outer surface that is pressed against the first bus bar 120. Unevenness corresponding to the unevenness structure 123 is formed in the pressing surface region. When the pressing surface region comes into pressure contact with the hole 121 or the periphery of the scheduled hole forming region, the unevenness is transferred to form the unevenness structure 123. In the present embodiment, the pressing surface region is provided with a plurality of convex portions having shapes and dimensions corresponding to the shapes and dimensions of the concave grooves 123a.

The protruding height of the convex portion in the unevenness of the pressing surface region is preferably greater than the depth of the concave portion 123a (concave groove 123a) of the unevenness structure 123. The protruding height of the convex portion refers to the dimensions of the convex portion in the protruding direction of the convex portion. The pressing surface region having such unevenness with a large protruding height may be pressed against the first bus bar 120 or the conductive member until only a part of the leading end side of each convex portion of the unevenness fits into the first bus bar 120 or the conductive member. In other words, the pressing surface region may be pressed against the first bus bar 120 or the conductive member to the extent that the concave portion formed between two convex portions in the pressing surface region does not completely fit into the first bus bar 120 or the conductive member.

Thereby, a part of the first bus bar 120 or the conductive member, which is pushed out by coming into pressure contact with the convex portion of the pressing surface region, can enter the concave portion formed between the convex portions. In this manner, a space is provided in which the part of the first bus bar 120 or the conductive member pushed out and raised enters the concave portion, and thus unevenness structure 123 is easily formed in the first bus bar 120 or the conductive member. Furthermore, when the part of the first bus bar 120 or the conductive member, which is pushed out by the convex portion of the pressing surface region, relieves into the concave portion, the depth of the formed concave portion 123a becomes larger than the depth to which the convex portion fits into the first bus bar 120 or the conductive member. This makes it possible to form the concave groove 123a with a sufficient depth while minimizing the force that presses the pressing member.

The step for forming a hole and the step for embossing the unevenness may be performed simultaneously or may be performed sequentially. Here, that the step for forming a hole and the step for embossing the unevenness are performed sequentially includes both a case where the step for embossing the unevenness is performed after the step for forming a hole and a case where the step for forming a hole is performed after the step for embossing the unevenness. In addition, that the step for forming a hole and the step for embossing the unevenness are performed simultaneously includes not only a case where the step for forming a hole and the step for embossing the unevenness are completely performed simultaneously, but also a case where only some of each step is performed in an overlapping manner.

When the step for forming a hole and the step for embossing the unevenness are performed simultaneously, the punch member, which punches the first bus bar 120 or the conductive member to form the hole 121, also serves as a pressing member, for example. In other words, while the hole 121 is being formed by the punch member, the unevenness structure 123 is formed around the hole 121.

When the step for forming a hole is performed before the step for embossing the unevenness, the pressing member is pressed around the hole 121 in the step for embossing the unevenness. Furthermore, when the step for embossing the unevenness is performed before the step for forming a hole, the hole 121 is formed near the unevenness region 122a, preferably in the center thereof, as described above.

The first bus bar 120 formed in this manner is combined with the main body 110 so as to be electrically connected to the electronic element 111, thereby manufacturing the electronic component 100.

Note that a series of steps including the step for forming a hole and the step for embossing the unevenness in the present method may be used as a method for manufacturing the first bus bar 120 instead of the electronic component 100 which is a part of the electronic component.

### (Method for Manufacturing Electric Device)

Hereinafter, a method for the electric device 1 according to the present embodiment (hereinafter, the method for manufacturing the electric device 1 as well as the method for manufacturing the electronic component 100 being sometimes referred to as the present method) will be described.

First, an overview of the present method will be described.

The electric device 1 manufactured by the present method includes the electronic component 100 and the second bus bar 200 coming into contact with the first bus bar 120, as described above, the electronic component 100 including the main body 110 including the electronic element 111 and the first bus bar 120 electrically connected to the electronic element 111. The first bus bar 120 includes the hole 121, and the unevenness region 122a having the unevenness structure 123 is formed around the hole 121 in the contact surface 122 where the hole 121 opens.

The present method includes a step for joining, in which the first bus bar 120 and the second bus bar 200 are joined.

In the step for joining, first, the first bus bar 120 and the second bus bar 200 are arranged such that the contact surface 122 in the first bus bar 120 faces the facing surface 210 in the second bus bar 200. Here, that the contact surface 122 and the facing surface 210 face each other means that the contact surface 122 and the facing surface 210 have the same direction component as shown in FIG. 3B, and preferably the contact surface 122 and the facing surface 210 are approximately parallel to each other.

In the step for joining, subsequently, the contact surface 122 and the facing surface 210 come into pressure contact with each other, and thus a part of the unevenness structure 123 engages with the second bus bar 200. The contact surface 122 and the facing surface 210 come into pressure contact with each other by stress applied to each other in the direction intersecting (preferably, orthogonal to) the contact surface between the contact surface 122 and the facing surface 210. Hereinafter, such a direction may be referred to as a pressure-contact direction of the contact surface 122 and the facing surface 210, or simply as a pressure-contact direction.

Here, the part of the unevenness structure 123 fitting into the second bus bar 200 is particularly the top portion 123b. The contact surface 122 is pressed against the facing surface 210 with a sufficient force for the top portion 123b to fit into the second bus bar 200. At least the top portion 123b and a part of the concave-groove wall portion 123a2 on the side of the top portion 123b fit into the second bus bar 200. The facing surface 210 is substantially planar before the fit-in, but as the top portion 123b fits into, the unevenness structure 123 is transferred to the facing surface 210, whereby the facing surface 210 becomes a surface having partially unevenness.

The contact surface 122 and the facing surface 210 may come into pressure contact with each other when the first bus bar 120 and the second bus bar 200 are firmly interposed between the shaft head portion 141 and the nut 143. Specifically, before the contact surface 122 and the facing surface 210 come into pressure contact with each other, the shaft member 140 may be loosely inserted into the first bus bar 120 and the second bus bar 200, and the nut 143 may be tightened to firmly interpose the first bus bar 120 and the second bus bar 200 between the shaft head portion 141 and the nut 143. Alternatively, the contact surface 122 and the facing surface 210 may come into pressure contact with each other by gripping with a jig (not shown), the shaft member 140 may be inserted in the gripped state, and the nut 143 may be tightened.

As described above, the first bus bar 120 includes the conductor portion 125 and the oxide film 126 that covers the conductor portion 125.

In the present embodiment, the contact surface 122 and the facing surface 210 come into pressure contact with each other in the above-described step for joining, whereby a part of the oxide film 126 coming into pressure contact with the second bus bar 200 is removed, and a part of the conductor portion 125 is exposed to become an exposed portion. The exposed portion and the second bus bar 200 come into contact with each other.

During the process in which the contact surface 122 and the facing surface 210 come into pressure contact with each other and the part of the first bus bar 120 (particularly, the top portion 123b and the part of the concave-groove wall portion 123a2 on the side of the top portion 123b) fits into the second bus bar 200, the first bus bar 120 and the second bus bar 200 rub against each other. Thus, the surface of the oxide film 126 rubbed by the second bus bar 200 in the oxide film 126 covering the outer surface of the first bus bar 120 is partially removed to become thinner, or is completely removed to expose the conductor portion 125. Specifically, in the present embodiment, at least the top portion 123b and the concave-groove wall portion 123a2 come into pressure contact with and rubs against the second bus bar 200. As a result, the oxide film 126 covering the top portion 123b or the concave-groove wall portion 123a2 is removed. More specifically, the oxide film 126 covering the part of the concave-groove wall portion 123a2 on the side of the top portion 123b is removed to expose the inner conductor portion 125, and the surface of the oxide film 126 covering the top portion 123b is partially removed to become thinner.

The reason why the aspect of removing the oxide film 126 at the top portion 123b differs from the aspect of removing the oxide film 126 at the concave-groove wall portion 123a2 is because the aspect of the pressure-contact between the top portion 123b and the facing surface 210 differs from that of the pressure-contact between the concave-groove wall portion 123a2 and the facing surface 210. Specifically, in the present embodiment, the flat top portion 123b is arranged approximately orthogonal to the pressure-contact direction. On the other hand, the concave-groove wall portion 123a2 is arranged parallel to the pressure-contact direction or, preferably, obliquely to the pressure-contact direction. For this reason, the oxide film 126 covering the concave-groove wall portion 123a2 is more likely to be peeled off due to the pressure contact between the first bus bar 120 and the second bus bar 200 than the oxide film 126 covering the top portion 123b. As a result, the oxide film 126 covering the concave-groove wall portion 123a2 is sufficiently removed enough to expose the conductor portion 125, and the oxide film 126 covering the top portion 123b is removed to the extent that the oxide film 126 remains thinly.

The part of the concave-groove wall portion 123a2, from which the oxide film 126 is removed, on the side of the top portion 123b becomes an exposed portion. At the exposed portion of the concave-groove wall portion 123a2, the second bus bar 200 is in direct contact with the conductor portion 125 of the first bus bar 120. At the top portion 123b, the oxide film 126 of the first bus bar 120 is in contact with the second bus bar 200.

In the present embodiment, the oxide film 126 covering the top portion 123b remains thinly, but alternatively to the present embodiment, the oxide film 126 covering the top portion 123b may be completely removed to expose the top portion 123b. In this case, the conductor portion 125 and the second bus bar 200 are in direct contact with each other in at least a part of the top portion 123b that is exposed after the oxide film 126 is removed.

Furthermore, the outer peripheral portion 122b may be or may not be in contact with the facing surface 210 of the second bus bar 200. When the outer peripheral portion 122b is in contact with the facing surface 210 of the second bus bar 200, the surface of the oxide film 126 covering a part of the outer peripheral portion 122b facing and being in contact with the second bus bar 200 may be removed to become thin. Alternatively, the oxide film 126 covering the part of the outer peripheral portion 122b may be removed enough to expose the conductor portion 125.

Alternatively to the present embodiment, even when the second bus bar 200 is pressure-contacted, the oxide film 126 may remain over the entire region of the unevenness structure 123 without being completely removed. Specifically, the oxide film 126, of which the surface is thinned by being partially peeled off due to rubbing, may remain over the entire region of the unevenness structure 123. In this case, the electrical connection between the second bus bar 200 and the first bus bar 120 is improved by the oxide film 126 that becomes thin. In addition, since the whole of the unevenness structure 123 including the concave-groove wall portion 123a2 and the like is the covering portion, the conductor portion 125 can be protected over approximately the entire region of the unevenness structure 123.

As described above, the second bus bar 200 also includes the second conductor portion 220 and the second oxide film 230 covering the second conductor portion 220. Since the top portion 123b and the concave-groove wall portion 123a2 rub against the second bus bar 200, the second oxide film 230 covering the second bus bar 200 is also removed to become thin, or is removed and peeled off enough to expose the conductor portion 125. Specifically, in the present embodiment, after the step for joining, a part of the outer surface of the second bus bar 200 facing the concave-groove wall portion 123a2 is a second exposed portion that is not covered with the second oxide film 230. In addition, after the step for joining, a part of the outer surface of the second bus bar 200 facing the top portion 123b has the second oxide film 230 that is worn away and becomes thin. The thickness of the second oxide film 230 covering the part of the outer surface of the second bus bar 200 facing the top portion 123b is smaller than the thickness of the second oxide film 230 covering the part of the outer surface of the second bus bar 200 facing the concave-groove bottom portion 123a1.

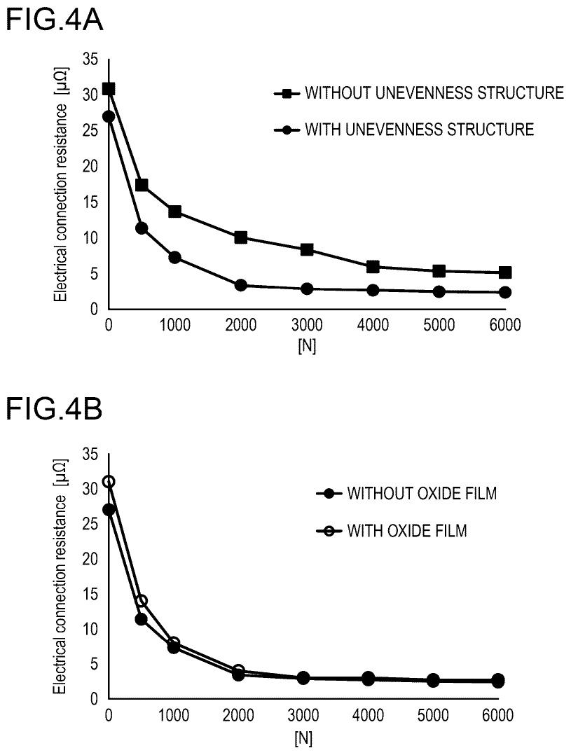

Here, with reference to FIGS. 4A and 4B, a case will be described in which the unevenness structure 123 is provided for the electric device 1 of the present embodiment to reduce the electrical connection resistance. In FIGS. 4A and 4B, a vertical axis indicates a value of the electrical connection resistance at the contact surface between the first bus bar 120 and the second bus bar 200 when the first bus bar 120 and the second bus bar 200 come into pressure contact with each other by a predetermined stress applied to each other. In FIGS. 4A and 4B, a horizontal axis indicates a magnitude of a bolt tightening load applied to allow the first bus bar 120 and the second bus bar 200 to come into pressure contact with each other.

FIG. 4A shows the electrical connection resistance at the contact surface when a bus bar simulating the first bus bar 120 of the present embodiment (hereinafter, such a bus bar being also referred to as the first bus bar 120) comes into pressure contact with the second bus bar 200 with loads of 0 [N] to 6000 [N]. For comparison with the first bus bar 120 including the unevenness structure 123, a bus bar having the flat contact surface 122 without the unevenness structure 123 (hereinafter, referred to as a first contrast bus bar) comes into pressure contact with the second bus bar 200 in the same manner. FIG. 4A also shows the electrical connection resistance at the contact surface when the first contrast bus bar comes into pressure contact with the second bus bar 200 with loads of 0 [N] to 6000 [N]. Specifically, as described above, the first bus bar 120 and the second bus bar 200 come into pressure contact with each other such that the contact surface 122 of the first bus bar 120 or the contact surface of the first contrast bus bar faces the facing surface 210 of the second bus bar 200. The pressure-contact state is maintained by the shaft member 140, and a current flows into the first bus bar 120 or the first contrast bus bar, and the second bus bar 200 to measure the electrical connection resistance at the contact surface between the bus bars.

The electrical connection resistance when the first bus bar 120 including the unevenness structure 123 is used is smaller than the electrical connection resistance when the first contrast bus bar is used, regardless of the load applied in the range of 0 [N] to 6000 [N]. In particular, when the load of 500 [N] to 3000 [N] is applied, the electrical connection resistance when the first bus bar 120 is used is smaller than the electrical connection resistance when the first contrast bus bar is used. On the other hand, even when the bus bars come into pressure contact with each other with the extremely large load of 6000 [N], the electrical connection resistance when the first bus bar 120 including the unevenness structure 123 is used is smaller than the electrical connection resistance when the first contrast bus bar is used. From the above results, it is confirmed that the electrical connection resistance can be reduced when the first bus bar 120 includes the unevenness structure 123.

Next, the electrical connection resistance is measured at the contact surface between the first bus bar 120 of which the surface is formed with the oxide film 126 (referred to as a coated first bus bar) or the first bus bar 120 not formed with the oxide film 126 (referred to as an uncovered first bus bar) and the second bus bar 200 is measured. The oxide film 126 of the covered first bus bar is formed artificially by placing the uncovered first bus bar in a thermostatic chamber maintained at 100° C. for 50 hours. The uncovered first bus bar may be considered as the first bus bar 120 including only the conductor portion 125 without the oxide film 126. Values of electrical connection resistance in the covered first bus bar and the uncovered first bus bar are shown in FIG. 4B.

As shown in FIG. 4B, when the bus bars come into pressure contact with each other with 0 [N] or 500 [N], the electrical connection resistance in the covered first bus bar is larger than the electrical connection resistance in the uncovered first bus bar. It is considered that the electrical connection resistance in the covered first bus bar is increased since the oxide film 126, which is insulating or has a higher resistance than the conductor portion 125, is located between the conductor portion 125 and the second bus bar 200.

On the other hand, when the bus bars come into pressure contact with each other with a load of equal to or more than 1000 [N], a difference between the electrical connection resistance in the covered first bus bar and the electrical connection resistance in the uncovered first bus bar is smaller than that when the load of 0 [N] or 500 [N] is applied. Furthermore, when the bus bars come into pressure contact with each other with a load of equal to or more than 3000 [N], the electrical connection resistance in the covered first bus bar is equal to the electrical connection resistance in the uncovered first bus bar. As described above, when the bus bars come into pressure contact with each other with a sufficient load, a part of the covered first bus bar (particularly, the top portion 123b) fits into the second bus bar 200, and the oxide film 126 of the covered first bus bar is removed, whereby the conductor portion 125 is exposed, or the oxide film 126 becomes thin. It is considered that the electrical connection resistance between the bus bars is reduced since the exposed conductor portion 125 and the second bus bar 200 are electrically connected without the oxide film 126 or the conductor portion 125 and the second bus bar 200 are electrically connected through the oxide film 126 that is thin and has low resistance. In addition, when the bus bars come into pressure contact with each other with equal to or more than 3000 [N], it is considered that the electrical connection resistance between the bus bars is reduced since the oxide film 126 is sufficiently removed, the conductor portion 125 is sufficiently exposed, and the conductor portion 125 and the second bus bar 200 are directly electrically connected to each other. As described above, even when the oxide film 126 covering the conductor portion 125 of the first bus bar 120 is formed, since the unevenness structure 123 is provided, the electrical connection resistance between the first bus bar 120 and the second bus bar 200 is reduced.

### Second Embodiment

### (Electronic Component)

FIG. 5A is a perspective view showing an example of an electronic component 100 according to the present embodiment.

First, an overview of the electronic component 100 according to the present embodiment will be described.

The electronic component 100 of the present embodiment includes a main body 110 and a bus bar (first bus bar 120), similarly to the electronic component 100 of the first embodiment. The main body 110 includes an electronic element 111. The first bus bar 120 is electrically connected to the electronic element 111. The first bus bar 120 includes a hole 121. An unevenness region 122a having an unevenness structure 123 is formed around the hole 121 in the contact surface 122 where the hole 121 opens.

Next, the electronic component 100 of the present embodiment will be described in detail.

The electronic component 100 of the present embodiment differs from that of the first embodiment in that a shaft member 140 comes into pressure contact with a peripheral wall surface 121b that defines the hole 121 (through hole 121), which is a through hole, and is erected in the hole 121.

In the present embodiment, the through hole 121 has a shape and dimensions that are small enough that a part of the first bus bar 120 interferes with the shaft member 140 when a shaft portion 142 of the shaft member 140 is inserted. For example, when the through hole 121 has a circular shape in a penetrating direction of the through hole 121 and a transverse section of the shaft portion 142 has a circular shape, a radius of the through hole 121 is smaller than a radius of the transverse section of the shaft portion 142.

As shown in FIG. 5B, in the present embodiment, a contact surface 122 includes an inner peripheral portion 122c located closer to the shaft member 140 than the unevenness region 122a. The inner peripheral portion 122c is a partial surface region of the contact surface 122. In the present embodiment in which the contact surface 122 is arranged to surround the periphery of the through hole 121 as viewed in the penetrating direction of the through hole 121, the inner peripheral portion 122c is a surface region that occupies a side closer to the through hole 121 than an inner peripheral edge of the unevenness region 122a as viewed in the penetrating direction of the through hole 121. In other words, in the present embodiment, as viewed in the penetrating direction of the through hole 121, the inner peripheral portion 122c is arranged to surround the periphery of the through hole 121, and the unevenness region 122a is arranged to surround the inner peripheral portion 122c. Alternatively to the present embodiment, when the unevenness region 122a is formed in a part in the diameter direction of the through hole 121 and is not formed in the other part in the diameter direction, the inner peripheral portion 122c is a region located between the peripheral wall surface 121b of the through hole 121 and the unevenness region 122a as viewed in the penetrating direction of the through hole 121.

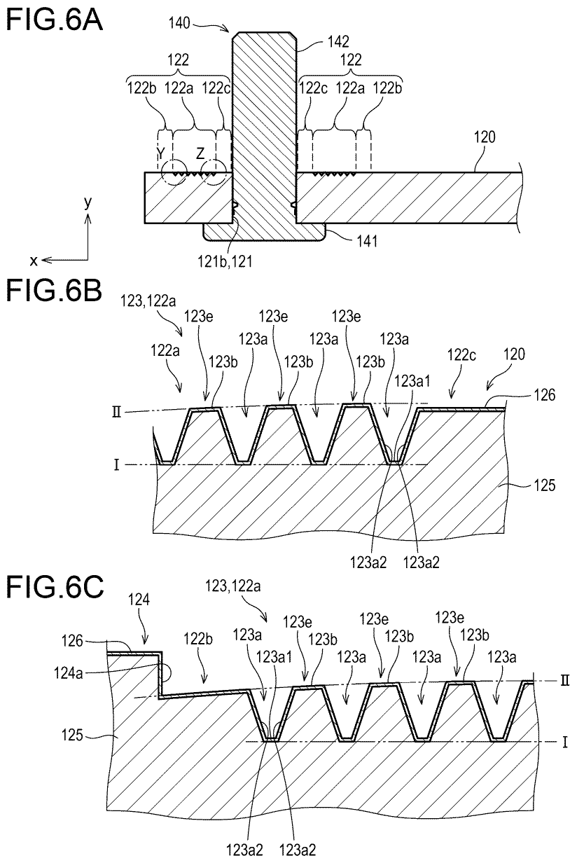

As shown in FIG. 6A, the inner peripheral portion 122c is flat. That the inner peripheral portion 122c is flat means that the unevenness structure 123 is not formed on the inner peripheral portion 122c. The inner peripheral portion 122c being flat includes the inner peripheral portion 122c being a curved surface that expands toward a protruding outer side of the first bus bar 120 or is recessed toward a protruding inner side. The inner peripheral portion 122c is preferably planar.

Since the inner peripheral portion 122c is flat, in a step for joining to be described below, the inner peripheral portion 122c abuts against a facing surface 210 of a second bus bar 200, and thus a positional relation between the first bus bar 120 and the second bus bar 200 can be aligned. Specifically, at the beginning or in the course of the process of allowing the second bus bar 200 and the first bus bar 120 to come into pressure contact with each other, the inner peripheral portion 122c comes into surface contact with the facing surface 210, whereby the contact surface 122 of the first bus bar 120 and the facing surface 210 of the second bus bar 200 are arranged parallel to each other.

In the present embodiment, as will be described below, the first bus bar 120 expands and is curved in the protruding direction of the unevenness structure 123. More specifically, a part close to the shaft member 140 expands most in the protruding direction. For this reason, a virtual plane II (a surface indicated by a tow-dot chin line in FIGS. 6B and 6C), which is a surface connecting protruding ends 123b of the protrusion portion 123e and will be described below, expands and is curved in the protruding direction of the unevenness structure 123. Specifically, a part of the virtual plane II close to the shaft member 140 expands most in the protruding direction. In other words, the virtual plane II shown in FIGS. 6B and 6C is arranged slantly upward from a lower left to an upper right in the drawings. Virtual planes I and II shown in FIGS. 6B and 6C, respectively, are surfaces that are connected to each other.

In FIG. 6A, the curved shape of the first bus bar 120 is not shown, and the first bus bar 120 is shown as being flat.

The curved shape of the first bus bar 120 (the curved shape of the virtual plane II) may be formed in a way such as cutting at the time of forming an outer shape of the first bus bar 120 or applying stress. Alternatively, the shape may be formed when the shaft member 140 is inserted into the through hole 121 by pressing.

In the present embodiment, the outer peripheral portion 122b is a region that formed to surround the periphery of the unevenness region 122a as viewed in the penetrating direction of the through hole 121 and has a predetermined width in the diameter direction of the through hole 121.

In the present embodiment, the inner peripheral portion 122c protrudes in the protruding direction of the unevenness structure 123 from the outer peripheral portion 122b. Since the inner peripheral portion 122c protrudes in the protruding direction of the unevenness structure 123 from the outer peripheral portion 122b, the inner peripheral portion 122c continuously comes into pressure contact with the second bus bar 200 until the outer peripheral portion 122b begins to come into pressure contact with the second bus bar 200 in the step for joining to be described below. The inner peripheral portion 122c is deformed by the stress applied from the second bus bar 200. Specifically, a part of the inner peripheral portion 122c comes into pressure contact with the shaft member 140 (see FIG. 3A) in a radially inward direction (a direction from a peripheral edge of the shaft member 140 toward an axial center) of the shaft member 140. Thus, a pressure-contact force between the shaft member 140 and the peripheral wall surface 121b of the through hole 121 increases, and the shaft member 140 and the first bus bar 120 are fixed more firmly.

Alternatively to the present embodiment, the inner peripheral portion 122c and the outer peripheral portion 122b may be arranged at the same height in the protruding direction of the unevenness structure 123. In other words, the inner peripheral portion 122c and the outer peripheral portion 122b may be arranged on the same plane. With such a configuration, when the first bus bar 120 and the second bus bar 200 come into pressure contact with each other in the step for joining to be described below, the first bus bar 120 and the second bus bar 200 come into contact with each other at the substantially same time at both a part of the contact surface 122 on the side close to the shaft member 140 and a part of the contact surface 122 on the peripheral edge side. Thus, the first bus bar 120 and the second bus bar 200 can come into pressure contact with each other while relative positions are aligned.

Alternatively to the present embodiment, the outer peripheral portion 122b may protrude in the protruding direction of the unevenness structure 123 from the inner peripheral portion 122c.

As shown in FIGS. 6A to 6C, the unevenness structure 123 includes a plurality of protrusion portions 123e. A protruding end 123b (a top portion 123b to be described below) of the protrusion portion 123e protrudes in the protruding direction of the unevenness structure 123 from the inner peripheral portion 122c. One protrusion portion 123e may protrude in the protruding direction of the unevenness structure 123 from the almost whole of the inner peripheral portion 122c. As described above, the virtual plane II is arranged slantly upward from a lower left to an upper right in the drawings. Accordingly, in the present embodiment, the protruding end 123b of the protrusion portion 123e (for example, the protrusion portion 123e on the right side in FIG. 6B) in the vicinity of the inner peripheral portion 122c protrudes in the protruding direction from the inner peripheral portion 122c. The other protrusion portions 123e may or may not protrude in the protruding direction from the inner peripheral portion 122c. In other words, the inner peripheral portion 122c may or may not protrude in the protruding direction from the other protrusion portions 123e. In the present embodiment, the inner peripheral portion 122c protrudes in the protruding direction of the unevenness structure 123 from the protrusion portions 123e arranged near the outer peripheral portion 122b.

Alternatively to the present embodiment, the protruding ends 123b of all the protrusion portions 123e in the unevenness structure 123 may protrude in the protruding direction of the unevenness structure 123 from the almost whole of the inner peripheral portion 122c.

In the present embodiment, the protruding end 123b of the protrusion portion 123e protrudes in the protruding direction of the unevenness structure 123 from the outer peripheral portion 122b.

Since the protruding end 123b of the protrusion portion 123e protrudes in the protruding direction of the unevenness structure 123 from the inner peripheral portion 122c, the protruding end 123b of the protrusion portion 123e abuts against the second bus bar 200 in the step for joining to be described below before the inner peripheral portion 122c abuts against the second bus bar 200. For this reason, the protrusion portion 123e including the protruding end 123b easily fits into the second bus bar 200 in the step for joining.

Alternatively to the present embodiment, the inner peripheral portion 122c and the protruding end 123b may be arranged in the protruding direction at approximately the same height in the unevenness structure 123. In addition, the inner peripheral portion 122c may protrude in the protruding direction of the unevenness structure 123 from the protruding end 123b of the protrusion portion 123e. In this case, the outer peripheral portion 122b may protrude in the protruding direction of the unevenness structure 123 from the protruding end 123b of the protrusion portion 123e, and the protruding end 123b of the protrusion portion 123e may protrude in the protruding direction from the outer peripheral portion 122b. Since the inner peripheral portion 122c protrudes in the protruding direction of the unevenness structure 123 from the protruding end 123b of the protrusion portion 123e, the inner peripheral portion 122c abuts against the facing surface 210 (see FIG. 3B) of the second bus bar 200 before the protruding end 123b abuts in the step for joining to be described below. Thus, as described above, the inner peripheral portion 122c is deformed by the stress from the second bus bar 200, and the pressure-contact force between the shaft member 140 and the peripheral wall surface 121b of the through hole 121 increases, whereby the shaft member 140 (see FIG. 3B) and the first bus bar 120 are fixed more firmly. Furthermore, since the flat inner peripheral portion 122c abuts against the facing surface 210 of the second bus bar 200 before the protruding end 123b abuts in the step for joining, the relative positions of the first bus bar 120 and the second bus bar 200 can be aligned as described above.

As shown in FIGS. 6B and 6C, the unevenness structure 123 has a bottomed concave portion 123a (concave groove 123a) as described above. A depth dimension of a part of the concave portion 123a is larger than a depth dimension of another part of the concave portion 123a arranged on the side close to the unevenness region 122a (the left side in the drawings, which is also simply referred to as a peripheral edge side of the unevenness region). Here, the depth of the concave portion 123a is a depth dimension of a bottom portion of the concave portion (concave-groove bottom portion 123a1) based on the virtual plane II. As described above, in the present embodiment, the virtual plane II is arranged slantly upward from a lower left to an upper right as shown in FIGS. 6B and 6C. At this time, the depth of the concave portion 123a may be the maximum depth dimension, the minimum depth dimension, or an average depth dimension of the bottom portion of the concave portion 123a based on the virtual plane II.

In the present embodiment, the concave portion 123a refers to a concave groove 123a. In the present embodiment, the depth dimension of the concave portion 123a can be regarded as a depth dimension from an upper end (one end continuing to the top portion 123b) of one of a pair of concave-groove wall portions 123a2, which define the concave groove 123a, to the concave-groove bottom portion 123a1.

That the depth dimension of the part of the concave portion 123a is larger than the depth dimension of another part of the concave portion 123a arranged on the peripheral edge side of the unevenness region means that a depth dimension of a partial length region in the concave groove 123a is larger than a depth dimension of another partial length region of the concave groove 123a arranged on the peripheral edge side of the unevenness region. Alternatively, that the depth dimension of the part of the concave portion 123a is larger than the depth dimension of another part of the concave portion 123a arranged on the peripheral edge side of the unevenness region may mean that a depth dimension of a partial length region in one concave groove 123a is larger than a depth dimension of a partial length region of another concave groove 123a arranged closer to the peripheral edge side of the unevenness region than the partial length region.

In the present embodiment, the protruding dimension of one protrusion portion 123e is larger than the protruding dimension of another protrusion portion 123e on the peripheral edge side of the unevenness region. In other words, the protruding end 123b of one protrusion portion 123e protrudes in the protruding direction of the unevenness structure 123 from the protruding end 123b of another protrusion portion 123e on the peripheral edge side of the unevenness region. Here, the protruding dimension of the protrusion portion 123e is a height of the protruding end 123b based on a height of a base end of the protrusion portion 123e in the protruding direction of the unevenness structure 123 (a height equal to that of the concave-groove bottom portion 123a1).

As will be described below, the first bus bar 120 and the second bus bar 200 are fixed by being interposed between the shaft head portion 141 and the nut 143. For this reason, the region of the unevenness region 122a on the side close to the shaft member 140 strongly comes into pressure contact with the second bus bar 200 rather than the region on the peripheral edge side of the unevenness region from the region of the unevenness region 122a. Therefore, the depth dimension of the concave groove 123a becomes larger in the region of the unevenness region 122a closer to the shaft member 140, and thus the second bus bar 200 can be fitted deep into the concave portion 123a in the region where the pressure-contact force between the first bus bar 120 and the second bus bar 200 is strong.

As described above, in the present embodiment, a part of the virtual plane II on the side close to the shaft member 140 expands most in the protruding direction of the unevenness structure 123. In other words, the protruding end 123b of one protrusion portion 123e protrudes in the protruding direction of the unevenness structure 123 from the protruding end 123b of another protrusion portion 123e on the peripheral edge side of the unevenness region. Furthermore, the bottom portions of the concave portions 123a are arranged at a uniform height (a height represented by the virtual plane I) in the protruding direction of the unevenness structure 123. In other words, the concave-groove bottom portions 123a1 are at the same height in the protruding direction over the entire length region of the concave grooves 123a, and the heights of the concave-groove bottom portions 123a1 of two adjacent concave grooves 123a are the same in the protruding direction.

Since the protruding end 123b of one protrusion portion 123e protrudes in the protruding direction of the unevenness structure 123 from the protruding end 123b of another protrusion portion 123e on the peripheral edge side of the unevenness region, the protrusion portion 123e arranged on the side of the shaft member 140 can be fitted into the second bus bar 200 in order in the step for joining to be described below.

Alternatively to the present embodiment, the virtual plane II may be a plane perpendicular to the penetrating direction of the through hole 121. In other words, the heights of the protruding ends of the plurality of protrusion portions 123e may be the same as each other in the protruding direction of the unevenness structure 123.

As shown in FIG. 6C, a part of the outer surface of the first bus bar 120 is an adjacent portion 124 that is adjacent to the contact surface 122 (the outer peripheral portion 122b) and arranged outward from the contact surface 122 (the outer peripheral portion 122b) in the diameter direction of the shaft member 140. In the present embodiment, a step is formed between the outer peripheral portion 122b and the adjacent portion 124 to rise from the outer peripheral portion 122b toward the adjacent portion 124. In other words, the adjacent portion 124 protrudes in the protruding direction of the unevenness structure 123 from the outer peripheral portion 122b, and a height in the protruding direction of a boundary between the adjacent portion 124 and the outer peripheral portion 122b changes suddenly. A surface standing up with respect to the contact portion 122 at the boundary between the adjacent portion 124 and the outer peripheral portion 122b is referred to as a step surface 124a of the step (hereinafter, simply referred to as a step surface 124a). The step surface 124a is arranged so as to intersect with the contact portion 122, and is preferably arranged perpendicular to the contact portion 122.

The step surface 124a can be formed by pressing a pressing member against the first bus bar 120 in the step for embossing the unevenness.

Alternatively to the present embodiment, the outer shape of the first bus bar 120, the through hole 121, and the unevenness structure 123 may be formed at the same time as described in the first embodiment. For example, when the outer shape of the first bus bar 120 and the through hole 121 are formed with a punch member, the unevenness structure 123 may be formed by a pressing surface region provided on the punch member. In this case, the step surface 124a may not be formed on the first bus bar 120.

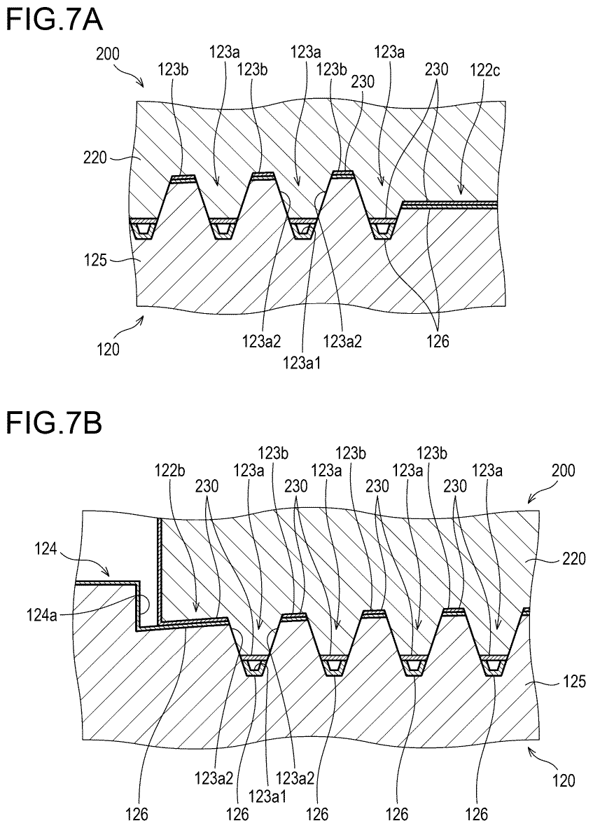

As shown in FIG. 7A or 7B, the electronic component 100 of the present embodiment has the following features as in the first embodiment.

The top portion 123b is flat which is a leading end protruding in the unevenness structure 123.

The unevenness structure 123 is formed by two or more bottomed concave grooves 123a aligned with each other. The width of the top portion 123b interposed between two concave grooves 123a is larger than the bottom portion of the concave groove (the concave-groove bottom portion 123a1).

The contact surface 122 includes the outer peripheral portion 122b, which is a portion adjacent to the unevenness region 122a, outside the unevenness region 122a. The top portion 123b protrudes in the protruding direction of the unevenness structure 123 from the outer peripheral portion 122b.

Moreover, the electronic component 100 of the present embodiment can be joined to the second bus bar and provided as a part of the electric device 1, similarly to the first embodiment. The electric device 1 has the following features as in the first embodiment.

The second bus bar 200 contacts with the first bus bar 120. The second bus bar 200 is in contact with the contact surface 122 at the facing surface 210 facing the contact surface 122. The top portion 123b, which is the leading end protruding in the unevenness structure 123, fits into the second bus bar 200.

The first bus bar 120 includes the conductor portion 125 and the oxide film 126. The oxide film 126 covers the conductor portion 125. The outer peripheral portion 122b is a covering portion that is covered with the oxide film 126. At least a part of the unevenness structure 123 is an exposed portion that is exposed from the oxide film 126. The exposed portion is buried in the second bus bar 200.

The unevenness structure 123 is formed by two or more bottomed concave grooves 123a aligned with each other. The concave groove 123a is defined by the bottom portion (concave-groove bottom portion 123a1) and the pair of wall portions (concave-groove wall portion 123a2) that sandwich the concave-groove bottom portion 123a1. The concave-groove wall portion 123a2 is arranged obliquely with respect to the outer peripheral portion 122b. At least a part of the concave-groove wall portion 123a2 is an exposed portion and is in contact with the second bus bar 200.

The second bus bar 200 includes a second conductor portion 220 and a second oxide film 230 that covers the second conductor portion 220. A part of the outer surface of the second bus bar 200 coming into contact with the first bus bar 120 is a second exposed portion in which the second conductor portion 220 is exposed. The other part of the outer surface of the second bus bar 200 is a second covering portion that is covered with the second oxide film 230.

Similarly to the first embodiment, the electronic component 100 of the present embodiment may be joined to the second bus bar 200 and provided as the electric device 1. Furthermore, the first bus bar 120 in the electronic component 100 of the present embodiment may be provided as a bus bar without including the main body 110.

### (Method for Manufacturing Electronic Component)

As in the first embodiment, a method for manufacturing the electronic component 100 of the present embodiment (hereinafter, also referred to as the present method) includes a step for forming a hole and a step for embossing the unevenness.

In the present embodiment, the present method includes a step for inserting that is performed after the step for forming a hole and before the step for embossing the unevenness. As shown in FIG. 6A, in the step for inserting, the shaft member 140 is inserted into the through hole 121 from the rear surface toward the contact surface 122 (in the y direction) while coming into pressure contact with the peripheral wall surface 121b that defines the through hole 121, and is erected in the through hole 121. That the shaft member 140 is erected in the through hole 121 means that the shaft member 140 is erected so as to intersect with, preferably perpendicular to the contact surface 122. In the present embodiment, the shaft member 140 is inserted into the through hole 121 from the other end opposite to the shaft head portion 141, and is inserted into the through hole 121 upward from below in FIG. 6A until the shaft head portion 141 abuts against the first bus bar 120.

When the shaft member 140 is inserted into the through hole 121, the surface region of the contact surface 122 around the through hole 121 may be pressed by a jig (not shown) in a direction opposite to the insertion direction of the shaft member 140. The jig may have a surface for pressing the entire or partial surface region of the contact surface 122, for example. Since the contact surface 122 is pressed by the jig in the direction opposite to the insertion direction of the shaft member 140, the first bus bar 120 can be prevented from being excessively deformed. After the step for inserting, the first bus bar 120 may be a flat plate without being curved, or may have a curved surface that expands slightly in the insertion direction of the shaft member 140 (upward in FIG. 6A) as described above. In FIG. 6A, the curved shape of the first bus bar 120 is not shown, and the first bus bar 120 is shown as being flat.

In the present embodiment, the pressing member includes a relief hole into which the shaft member 140 is housed in the step for embossing the unevenness. In the step for embossing the unevenness in which the pressing member comes into pressure contact with the first bus bar 120 into which the shaft member 140 is inserted, the shaft member 140 is housed in the relief hole. The relief hole is a bottomed hole or a through hole provided in the pressing member. A depth direction of the relief hole is a direction in which the pressing member comes into pressure contact with the first bus bar 120. In the present embodiment, the shape and dimensions of a transverse section in the depth direction of the relief hole are substantially the same as the shape and dimensions of the transverse section of the shaft portion 142. Thus, the pressing member can come into pressure contact with the first bus bar 120 at a desired position.

Alternatively to the present embodiment, the shape and dimensions of the transverse section in the depth direction of the relief hole may be larger than the shape and dimensions of the transverse section of the shaft portion 142. Thus, a part of the contact surface 122, which is scheduled to form the inner peripheral portion 122c, does not come into pressure contact with the pressing surface region of the pressing member. Therefore, the inner peripheral portion 122c can protrude in the protruding direction of the unevenness structure 123 from the outer peripheral portion 122b in the first bus bar 120 after the step for embossing the unevenness.

The shaft member 140 is inserted before the unevenness structure 123 is formed, and thus the outer surface of the first bus bar 120 is supported with the jig, whereby it is possible to prevent the unevenness structure 123 from being deformed, or prevent the unevenness structure 123 from being crushed and the unevenness region 122a from being made approximately flat.

In the present embodiment, the step for embossing the unevenness is performed after the step for inserting. This makes it possible to prevent the jig from coming into pressure contact with the unevenness structure 123 during the step for inserting and to prevent the unevenness structure 123 from being deformed.

Alternatively to the present embodiment, the step for inserting and the step for embossing the unevenness may be performed simultaneously. That the step for inserting and the step for embossing the unevenness are performed simultaneously means that at least some of the step for inserting and at least some of the step for embossing the unevenness are performed in an overlapping manner. Specifically, after the pressing member is arranged on the first bus bar 120 such that the pressing surface region is in contact with the contact surface 122 of the first bus bar 120, the shaft member 140 may be inserted into the through hole 121 of the first bus bar 120. The first bus bar 120 expands in the insertion direction of the shaft member 140 by the insertion of the shaft member 140, and thus the first bus bar 120 and the pressing member may come into pressure contact with each other. Alternatively, the shaft member 140 is inserted, and the shaft head portion 141 biases the first bus bar 120, whereby the first bus bar 120 and the pressing member may come into pressure contact with each other to form the unevenness structure 123.

Moreover, the step for inserting may be performed after the step for embossing the unevenness. For example, the shaft member 140 may be inserted from the rear surface of the first bus bar 120 toward the contact surface 122 (from the first bus bar 120 toward the second bus bar 200) in a state in which the first bus bar 120 and the second bus bar 200 are in contact with each other with the contact surface 122 and the facing surface 210 facing each other. In this case, as the shaft member 140 is inserted into the through hole 121, the first bus bar 120 expands in the insertion direction of the shaft member 140, and the first bus bar 120 begins to bite into, or further bites into the second bus bar 200. Thus, the top portion 123b may fit into the second bus bar 200. In this case, preferably, the shaft member 140 is loosely inserted into the hole provided in the second bus bar 200.

The present invention is not limited to the above-described embodiments, and includes various modifications, improvements, and other aspects as long as the object of the present invention is achieved. Hereinafter, the first and second embodiments may be collectively referred to as the present embodiment.

The following modifications can be combined as appropriate.

When the hole 121 is a bottomed concave portion, the shaft portion 142 may be joined to the shaft member 140 and the first bus bar 120 by bonding with an adhesive, brazing, or the like.

The electric device 1, the electronic component 100, or the first bus bar 120 in the present embodiment is not limited to those manufactured by the above-described manufacturing method. For example, the unevenness structure 123 is not limited to be formed by pressure contact of the pressing member. The unevenness structure 123 may be formed by laser irradiation or may be physically cut by a cutting blade.

### REFERENCE SIGNS LIST

1 electric device
100 electronic component
110 main body
111 electronic element
120 first bus bar
121 hole, through hole
121b peripheral wall surface
122 contact surface
122a unevenness region
122b outer peripheral portion
122c inner peripheral portion
123 unevenness structure
123a concave groove, concave portion
123a1 concave-groove bottom portion
123a2 concave-groove wall portion
123b top portion, protruding end
123e protrusion portion
124 adjacent portion
124a step surface
125 conductor portion
126 oxide film
140 shaft member
141 shaft head portion
142 shaft portion
143 nut
200 second bus bar
210 facing surface
220 second conductor portion
230 second oxide film

The above embodiments involves the following technical ideas.

(1) An electronic component including: a main body including an electronic element; and a bus bar that is electrically connected to the electronic element, in which
the bus bar includes a hole, and
an unevenness region having an unevenness structure is formed around the hole in a contact surface where the hole opens.

(2) In the electronic component according to (1), a top portion, which is a leading end protruding in the unevenness structure, is flat.

(3) In the electronic component according to (2), the unevenness structure is formed by two or more concave grooves, each having a bottom and aligned with each other, and
the top portion interposed between two of the concave grooves has a larger width than a bottom portion of the concave grooves.

(4) In the electronic component according to any one of (1) to (3), a top portion, which is a leading end protruding in the unevenness structure, protrudes farther in a protruding direction of the unevenness structure than an outer peripheral portion which is a part of the contact surface and is adjacent to the unevenness region outside the unevenness region.

(5) An electric device including: an electronic component including a main body including an electronic element and a bus bar electrically connected to the electronic element; and a second bus bar that is in contact with the bus bar, in which
the bus bar includes a hole,
an unevenness region having an unevenness structure is formed around the hole in a contact surface where the hole opens,
the second bus bar is in contact with the contact surface at a facing surface that faces the contact surface, and
a top portion, which is a leading end protruding in the unevenness structure, fits into the second bus bar.

(6) In the electric device according to (5), the bus bar includes a conductor portion and an oxide film that covers the conductor portion,
the contact surface includes an outer peripheral portion that is a part adjacent to the unevenness region outside the unevenness region,
the outer peripheral portion is a covering portion that is covered with the oxide film,
at least a part of the unevenness structure is an exposed portion that is exposed from the oxide film, and
the exposed portion is buried in the second bus bar.

(7) In the electric device according to (6), the unevenness structure is formed by two or more bottomed concave grooves aligned with each other,
the concave groove is defined by a bottom portion and a pair of wall portions that sandwich the bottom portion,
the wall portion is arranged obliquely with respect to the outer peripheral portion, and
at least a part of the wall portion is the exposed portion, and is in contact with the second bus bar.

(8) In the electric device according to any one of (5) to (7), the second bus bar includes a second conductor portion and a second oxide film that covers the second conductor portion,
a part of an outer surface of the second bus bar that is in contact with the bus bar is a second exposed portion where the second conductor portion is exposed, and
another part of the outer surface of the second bus bar is a second covering portion that is covered with the second oxide film.

(9) A bus bar including a hole that is a conductor, in which
an unevenness region having an unevenness structure is formed around the hole in a contact surface where the hole opens.

(10) A method for manufacturing an electronic component including a main body including an electronic element, and a bus bar that is electrically connected to the electronic element, the method including:
forming a hole in a scheduled hole forming region on the bus bar; and
embossing an unevenness structure by pressing a pressing member against the hole or a periphery of the scheduled hole forming region to form the unevenness structure around the hole or the scheduled hole forming region, in which
forming a hole and embossing the unevenness structure are performed simultaneously or sequentially.

(11) A method for manufacturing an electric device including an electronic component including a main body including an electronic element and a bus bar electrically connected to the electronic element, and a second bus bar that is in contact with the bus bar, in which
the bus bar includes a hole,
an unevenness region having an unevenness structure is formed around the hole in a contact surface where the hole opens, and
the method includes:
   arranging the bus bar and the second bus bar such that the contact surface faces a facing surface of the second bus bar and
   allowing the contact surface and the facing surface to come into pressure contact with each other such that a part of the unevenness structure fits into the second bus bar.
(12) In the method for manufacturing an electric device according to (11), the bus bar includes a conductor portion and an oxide film that covers the conductor portion,
the contact surface and the facing surface come into pressure contact with each other, whereby a part of the oxide film coming into pressure contact with the second bus bar is removed, and a part of the conductor portion is exposed to become an exposed portion, and
the exposed portion and the second bus bar are in contact with each other.

1. An electronic component comprising:
a main body including an electronic element; and
a bus bar that is electrically connected to the electronic element, wherein
the bus bar includes a hole, and
an unevenness region having an unevenness structure is formed around the hole in a contact surface where the hole opens.

2. The electronic component according to claim 1, wherein a top portion, which is a leading end protruding in the unevenness structure, is flat.

3. The electronic component according to claim 2, wherein the unevenness structure is formed by two or more concave grooves, each having a bottom and aligned with each other, and
the top portion interposed between two of the concave grooves has a larger width than a bottom portion of the concave grooves.

4. The electronic component according to claim 1, wherein a top portion, which is a leading end protruding in the unevenness structure, protrudes farther in a protruding direction of the unevenness structure than an outer peripheral portion which is a part of the contact surface and is adjacent to the unevenness region outside the unevenness region.

5. An electric device comprising:
an electronic component including a main body including an electronic element and a bus bar electrically connected to the electronic element; and
a second bus bar that is in contact with the bus bar, wherein
the bus bar includes a hole,
an unevenness region having an unevenness structure is formed around the hole in a contact surface where the hole opens,
the second bus bar is in contact with the contact surface at a facing surface that faces the contact surface, and
a top portion, which is a leading end protruding in the unevenness structure, fits into the second bus bar.

6. The electric device according to claim 5, wherein the bus bar includes a conductor portion and an oxide film that covers the conductor portion,
the contact surface includes an outer peripheral portion that is a part adjacent to the unevenness region outside the unevenness region,
the outer peripheral portion is a covering portion that is covered with the oxide film,
at least a part of the unevenness structure is an exposed portion that is exposed from the oxide film, and
the exposed portion is buried in the second bus bar.

7. The electric device according to claim 6, wherein the unevenness structure is formed by two or more bottomed concave grooves aligned with each other,
the concave groove is defined by a bottom portion and a pair of wall portions that sandwich the bottom portion,
the wall portion is arranged obliquely with respect to the outer peripheral portion, and
at least a part of the wall portion is the exposed portion, and is in contact with the second bus bar.

8. The electric device according to claim 5, wherein the second bus bar includes a second conductor portion and a second oxide film that covers the second conductor portion,
a part of an outer surface of the second bus bar that is in contact with the bus bar is a second exposed portion where the second conductor portion is exposed, and
another part of the outer surface of the second bus bar is a second covering portion that is covered with the second oxide film.

9. A bus bar comprising a hole that is a conductor, wherein
an unevenness region having an unevenness structure is formed around the hole in a contact surface where the hole opens.

10. A method for manufacturing the electronic component of claim 1, the method comprising:
forming the hole in a scheduled hole forming region on the bus bar; and
embossing the unevenness structure by pressing a pressing member against the hole or a periphery of the scheduled hole forming region to form the unevenness structure around the hole or the scheduled hole forming region, wherein
forming the hole and embossing the unevenness structure are performed simultaneously or sequentially.

11. A method for manufacturing the electric device of claim 5, the method comprising:
arranging the bus bar and the second bus bar such that the contact surface faces the facing surface of the second bus bar and
allowing the contact surface and the facing surface to come into pressure contact with each other such that the top portion of the unevenness structure fits into the second bus bar.

12. The method for manufacturing an electric device according to claim 11, wherein the bus bar includes a conductor portion and an oxide film that covers the conductor portion,
the contact surface and the facing surface come into pressure contact with each other, whereby a part of the oxide film coming into pressure contact with the second bus bar is removed, and a part of the conductor portion is exposed to become an exposed portion, and
the exposed portion and the second bus bar are in contact with each other.
